(19) United States
(12) Patent Application Publication
(10) Pub. No.: US 2022/0197527 A1
(43) Pub. Date: Jun. 23, 2022

(54) STORAGE SYSTEM AND METHOD OF DATA AMOUNT REDUCTION IN STORAGE SYSTEM

(71) Applicant: Hitachi, Ltd., Tokyo (JP)

(72) Inventors: Shimpei NOMURA, Tokyo (JP); Mitsuo HAYASAKA, Tokyo (JP); Yuto KAMO, Tokyo (JP)

(73) Assignee: Hitachi, Ltd.

(21) Appl. No.: 17/473,804

(22) Filed: Sep. 13, 2021

(30) Foreign Application Priority Data
Dec. 23, 2020 (JP) 2020-214037

(51) Int. Cl. G06F 3/06

(52) U.S. Cl. CPC G06F 3/0641; G06F 3/0673; G06F 3/0659; G06F 3/0608

(57) ABSTRACT

To attempt to reduce a processing load by making it unnecessary to perform a task of searching for similar data when a delta compression process is performed.

A storage system has a deduplication function of performing deduplication on a plurality of duplicate pieces of the data and a delta compression function of storing differences between a plurality of similar pieces of the data. When a write request to update the stored data is received, in a case where the deduplication has been performed on the data before being updated according to the write request, and the data after being updated does not share duplicate data with second data, a processor of the storage system performs the delta compression of generating and storing a difference between the data before being updated and the data after being updated.

### BACKGROUND OF THE INVENTION

### 1. Field of the Invention

The present invention relates to a storage system and a method of data amount reduction in a storage system.

### 2. Description of the Related Art

Along with an increase in data, there is an increasing demand for technologies for volume reduction in storage systems. Accordingly, it is attempted to reduce data storage costs for users by providing volume reduction functions such as data compression or deduplication not only in storage systems installed at data centers, but also in edge servers arranged at positions close to the users.

As one of volume reduction technologies, there is a delta encoding process (delta compression process or Delta-Compression; hereinafter, consistently referred to as a “delta compression process”). In this technology, in a case where there is data in a storage system that is similar to data to be stored, only difference data between the data to be stored and the similar data is stored on the storage system so as to be able to reduce the data volume. By using a delta compression process along with data compression and deduplication, a more significant data reduction effect can be expected.

As a storage system by which it is attempted to reduce a data amount by a delta compression process, there is a technology disclosed in U.S. Pat. No. 8,751,462. In this U.S. Pat. No. 8,751,462, in a case where duplicate data of data to be stored is not found in a storage system having a deduplication function, similar data is searched for, and a delta compression process is applied.

### SUMMARY OF THE INVENTION

Searches for similar data in delta compression processes including the technology disclosed in U.S. Pat. No. 8,751,462 are performed by comparing values that are referred to as sketches calculated from data. If sketches calculated from each piece of data on a storage system are gathered and kept being recorded on a table for searches of similar data, the size of the table becomes too large to be stored on a memory.

Accordingly, frequent disk access occurs in table searches, and it takes a very long time to perform similar data searches; therefore, it is not realistic to actually find similar data from data stored on the storage system. As a result, it becomes impossible to obtain advantages of delta compression processes. In addition, even if similar data is found, the volume cannot be reduced in some cases even if a delta compression process is implemented in a case where the similarity is low.

The present invention has been made in view of the circumstance described above, and an object of the present invention is to provide a storage system and a method of data amount reduction in a storage system by which it is possible to attempt to reduce the processing load by making it unnecessary to perform a similar data search task when a delta compression process is performed.

In order to solve the problems described above, a storage system according to one aspect of the present invention includes: a storage device that stores data; and a processor that processes the data stored on the storage device, in which the storage system has a deduplication function of performing deduplication on a plurality of duplicate pieces of the data and a delta compression function of storing differences between a plurality of similar pieces of the data, and when a write request to update the stored data is received, in a case where the deduplication has been performed on the data before being updated according to the write request, and the data after being updated does not share duplicate data with second data, the processor performs the delta compression of generating and storing a difference between the data before being updated and the data after being updated.

According to the present invention, it is possible to attempt to reduce a processing load by making it unnecessary to perform a task of searching for similar data when a delta compression process is performed.

### BRIEF DESCRIPTION OF THE DRAWINGS

FIG. 1 is a block diagram depicting the schematic configuration of a storage system according to a first embodiment;

FIG. 2 is a figure depicting an example of the configuration of data stored on the storage system according to the first embodiment;

FIG. 3 is a figure for explaining an example of a chunk delta compression process;

FIG. 4 is a figure depicting an example of the configuration of content management tables of the storage system according to the first embodiment;

FIG. 5 is a figure depicting an example of the configuration of duplicate chunk management tables of the storage system according to the first embodiment;

FIG. 6 is a figure depicting an example of the configuration of duplicate chunk determination tables of the storage system according to the first embodiment;

FIG. 7 is a flowchart depicting an example of a content data reduction process of the storage system according to the first embodiment;

FIG. 8 is a flowchart depicting an example of a chunk data reduction process of the storage system according to the first embodiment;

FIG. 9 is a flowchart depicting a chunk deduplication process of the storage system according to the first embodiment;

FIG. 10 is a flowchart depicting an example of a chunk delta compression process of the storage system according to the first embodiment;

FIG. 11 is a flowchart depicting an example of a data non-reduction chunk process of the storage system according to the first embodiment;

FIG. 12 is a flowchart depicting an example of a chunk read process of the storage system according to the first embodiment;

FIG. 13 is a flowchart depicting an example of a chunk updating process of the storage system according to the first embodiment;

FIG. 14 is a flowchart depicting an example of a content data reduction process of the storage system according to a second embodiment;

FIG. 15 is a flowchart depicting an example of a chunk data reduction process of the storage system according to the second embodiment;

FIG. 16 is a flowchart depicting an example of a pre-updating chunk selection process of the storage system according to the second embodiment;

FIG. 17 is a flowchart depicting a chunk deduplication process of the storage system according to the second embodiment;

FIG. 18 is a flowchart depicting an example of a chunk delta compression process of the storage system according to the second embodiment;

FIG. 19 is a figure depicting an example of the configuration of duplicate chunk management tables of the storage system according to a third embodiment;

FIG. 20 is a flowchart depicting an example of a newly created content data reduction process of the storage system according to the third embodiment;

FIG. 21 is a flowchart depicting an example of a pre-updating content selection process of the storage system according to the third embodiment;

FIG. 22 is a flowchart depicting a chunk deduplication process of the storage system according to the third embodiment;

FIG. 23 is a flowchart depicting a duplicate chunk storing content chunk movement process of the storage system according to the third embodiment;

FIG. 24 is a block diagram depicting the schematic configuration of the storage system according to a fourth embodiment;

FIG. 25 is a figure depicting an example of the configuration of data stored on the storage system according to the fourth embodiment;

FIG. 26 is a figure for explaining an example of a block data delta compression process;

FIG. 27 is a figure depicting an example of the configuration of address conversion tables of the storage system according to the fourth embodiment;

FIG. 28 is a figure depicting an example of the configuration of block management tables of the storage system according to the fourth embodiment;

FIG. 29 is a figure depicting an example of the configuration of duplicate block determination tables of the storage system according to the fourth embodiment;

FIG. 30 is a flowchart depicting an example of a block data reduction process of the storage system according to the fourth embodiment;

FIG. 31 is a flowchart depicting a block deduplication process of the storage system according to the fourth embodiment;

FIG. 32 is a flowchart depicting an example of a block delta compression process of the storage system according to the fourth embodiment;

FIG. 33 is a flowchart depicting an example of a data non-reduction block process of the storage system according to the fourth embodiment;

FIG. 34 is a flowchart depicting an example of a block read process of the storage system according to the fourth embodiment;

FIG. 35 is a flowchart depicting an example of a block updating process of the storage system according to the fourth embodiment;

FIG. 36 is a block diagram depicting the schematic configuration of the storage system according to a fifth embodiment;

FIG. 37 is a figure depicting an example of the configuration of data stored on the storage system according to the fifth embodiment;

FIG. 38 is a figure depicting an example of the configuration of content management tables of the storage system according to the fifth embodiment;

FIG. 39 is a figure depicting an example of the configuration of a special write command of the storage system according to the fifth embodiment;

FIG. 40 is a flowchart depicting an example of an NAS block updating process of the storage system according to the fifth embodiment; and

FIG. 41 is a flowchart depicting an example of a block delta compression process of the storage system according to the fifth embodiment.

### DESCRIPTION OF THE PREFERRED EMBODIMENTS

Hereinafter, embodiments of the present invention are explained with reference to the figures. Note that the embodiments explained below do not limit the invention according to claims, and all of elements and combinations thereof explained in the embodiments are not necessarily essential to the solution of the invention.

A storage system in the present embodiments has the following configuration, for example. That is, it is considered that a delta compression process can produce a significant data reduction effect by being applied to a case where copied files (data) are kept being updated. In view of this, in the storage system in the present embodiments, a chunk for which deduplication has been effective before the chunk is updated, but is no longer effective because the chunk has been partially updated is subjected to a delta compression process with the chunk before being updated, and thereby the data volume can be reduced without performing a similar data search task.

For example, it is attempted to realize data reduction by identifying, from file structure management data (details are mentioned below), a chunk that the file has referenced before the file is updated, and performing a delta compression process between the file and the chunk. That is, (1) a deduplication process is performed on a target chunk; (2) in a case where the target chunk is non-duplicate data in (1), structure management data is checked to find whether or not the chunk before being updated is a duplicate chunk; (3) in a case where the chunk before being updated is a non-duplicate chunk, the chunk before being updated is overwritten; (4) in a case where the chunk before being updated is a duplicate chunk, a delta compression process is applied to the new and old data; and (5) in a case where the data amount is reduced from the data amount of the original data due to the delta compression process, the data having been subjected to the delta compression process is stored on a storage device. In a case where the data amount is not reduced, the original data is stored on the storage device.

Note that a “memory” in the following explanation means one or more memories, and may be a main storage device, typically. At least one memory in a memory section may be a volatile memory or may be a non-volatile memory.

In addition, a “processor” in the following explanation is one or more processors. Typically, at least one processor is a microprocessor like a central processing unit (CPU), but may be another type of processor like a graphics processing unit (GPU). At least one processor may be a single-core processor or may be a multi-core processor.

In addition, at least one processor may be a processor in a broad sense such as a hardware circuit (e.g. a field-programmable gate array (FPGA) or an application specific integrated circuit (ASIC)) that performs some or all of processes.

In the present disclosure, a storage device includes one storage drive such as one hard disk drive (HDD) or solid state drive (SSD), a RAID apparatus including a plurality of storage drives and a plurality of RAID apparatuses. In addition, in a case where a drive is an HDD, for example, the HDD may include a serial attached SCSI (SAS) HDD or may include a nearline SAS (NL-SAS) HDD.

In addition, in the following explanation, expressions like “xxx table” are used in some cases to explain information that gives output in response to input. This information may be data with any type of structure, and may be a learning model like a neural network that generates output in response to input. Accordingly, the “xxx table” can be said to be “xxx information.”

In addition, in the following explanation, the configuration of each table is merely an example. One table may be divided into two or more tables, and all or some of two or more tables may be one table.

In addition, while processes are explained as being performed by a “program” in some cases in the following explanation, by being executed by a processor, the program performs the determined processes while using storage resources (e.g. a memory) and/or a communication interface device (e.g. a port) as appropriate, and therefore the processes may be explained as being performed by the program. Processes explained as being performed by a program may be considered as processes to be performed by a processor or a computer having the processor.

Programs may be installed on an apparatus like a computer, or may exist in a program distribution server or a computer-readable (e.g. non-transitory) recording medium, for example. In addition, in the following explanation, two or more programs may be realized as one program, or one program may be realized as two or more programs.

In addition, in the following explanation, in a case where an explanation is given without making distinctions between elements of the same type, reference characters (or common reference characters in the reference characters) are used, and in a case where an explanation is given by making distinctions between elements of the same type, identification numbers (or reference characters) of the elements are used, in some cases.

### First Embodiment

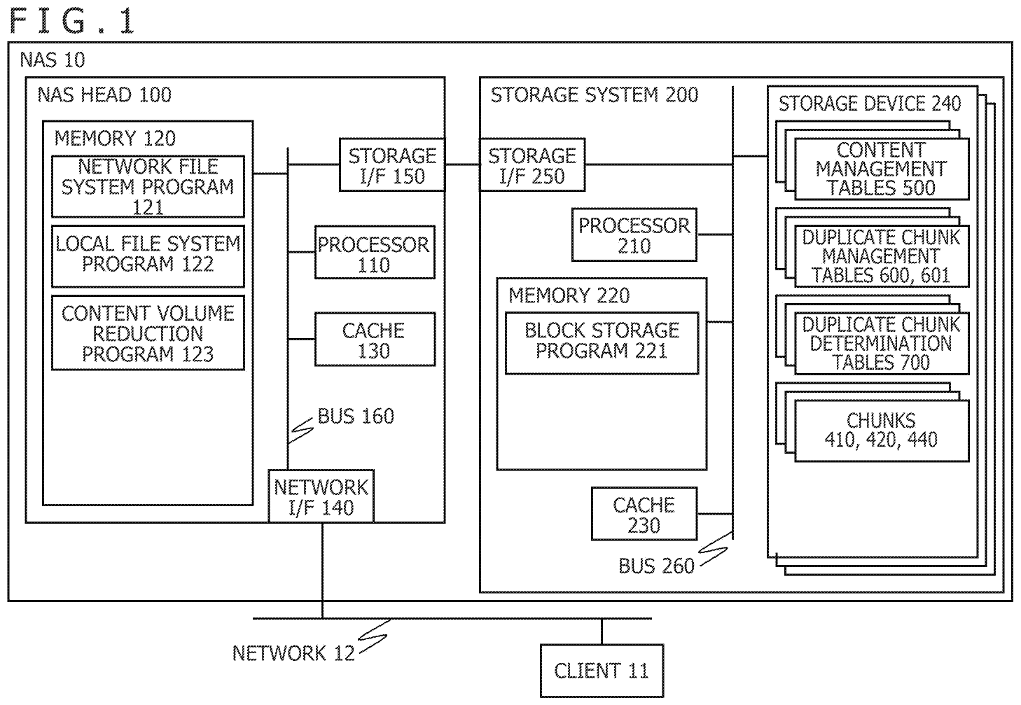

FIG. 1 is a figure depicting an example of the schematic configuration of a network attached storage (NAS) 10 which is an example of a storage system according to an embodiment.

The NAS 10 has an NAS head 100 as a controller and a storage system 200.

The NAS head 100 has: a processor 110 that performs the overall operation control of the NAS head 100 and the NAS 10; a memory 120 that temporarily stores programs and data to be used for the operation control of the processor 110; a cache 130 that temporarily stores data to be written from a client 11 via a network 12 and data read from the storage system 200; a network interface (I/F) 140 that performs communication with the client 11 via the network 12; and a storage interface (I/F) 150 that performs communication with the storage system 200. The processor 110, the memory 120, the cache 130, the network I/F 140, and the storage I/F 150 are mutually connected by a bus 160.

The storage system 200 also has: a processor 210 that performs the operation control of the storage system 200; a memory 220 that temporarily stores programs and data to be used for the operation control of the processor 210; a cache 230 that temporarily stores data to be written from the NAS head 100 and data read from a storage device 240; the storage device 240 on which data is stored; and a storage interface (I/F) 250 that performs communication with the NAS head 100. The processor 210, the memory 220, the cache 230, the storage device 240, and the storage I/F 250 are mutually connected by a bus 260.

The memory 120 stores a network storage program 121, a local file system program 122, and a content volume reduction program 123.

The network storage program 121 receives various types of requests from the client 11, and processes protocols included in the requests. The local file system program 122 provides a file system to the client 11.

The content volume reduction program 123 is a program which is a feature of the storage system (NAS 10) in the present embodiment, and performs a volume reduction process on contents stored on the storage system 200. Details of the operation of the content volume reduction program 123 are mentioned below.

The storage device 240 stores content management tables 500, duplicate chunk management tables 600, duplicate chunk determination tables 700, and chunks 410, 420 and 440.

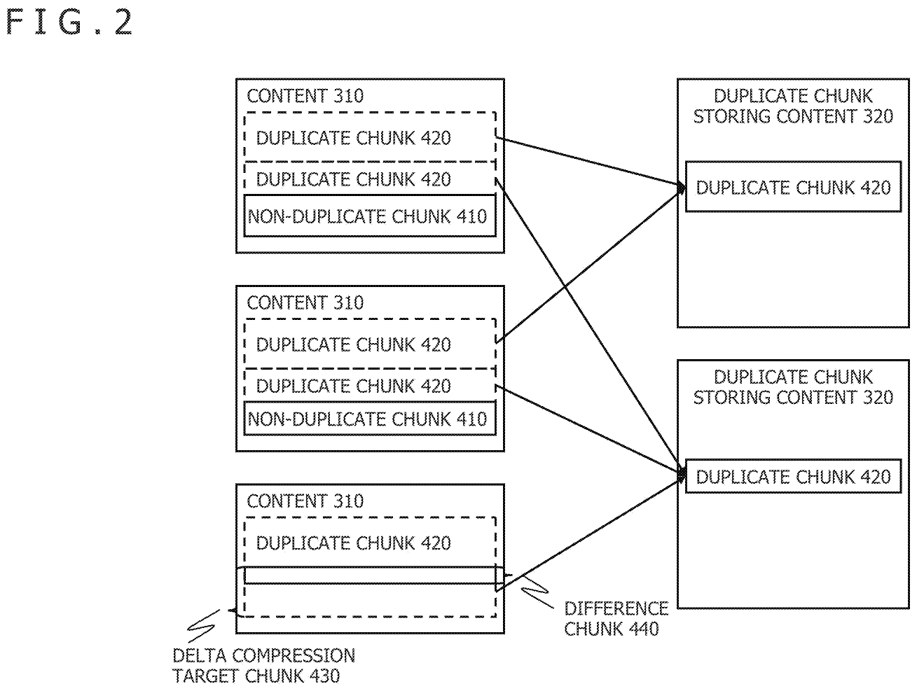

FIG. 2 is a figure depicting an example of the configuration of data stored on the NAS 10 according to the first embodiment.

In the NAS 10 in the present embodiment, files which are units of data for which the client 11 is to perform operation on the NAS 10, that is, contents 310, are divided into a plurality of data units, and stored on the storage system 200. In the first embodiment (and second and third embodiments mentioned below), the contents 310 are divided into chunks 410, 420, and 440 whose data lengths are variable, and are stored on the storage system 200. At this time, the content volume reduction program 123 performs a deduplication process and a delta compression process on the chunks 410, 420, and 440.

More specifically, the content volume reduction program 123 stores, on the storage system 200, and more specifically on the storage device 240, only one duplicate chunk 420 of chunks (hereinafter, referred to as duplicate chunks 420) with duplicate data in a plurality of contents 310 (deduplication process). In addition, a chunk that is similar to the duplicate chunks 420 is identified as a delta compression target chunk 430, and a difference chunk 440 which is the difference between the duplicate chunks 420 and the delta compression target chunk 430 is stored on the storage device 240 (delta compression process). Then, chunks that are treated as targets of neither a deduplication process nor a delta compression process are stored on the storage device 240 as non-duplicate chunks 410. Hereinafter, a content having one duplicate chunk 420 as real data is referred to as a duplicate chunk storing content 320.

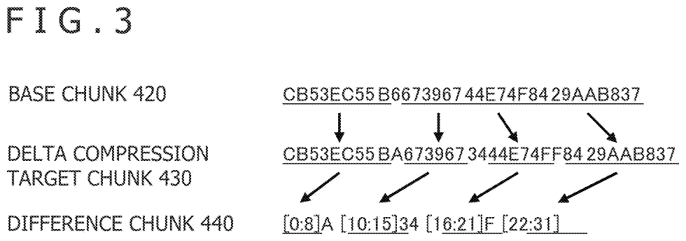

FIG. 3 is a figure for explaining an example of a chunk delta compression process.

The content volume reduction program 123 detects a delta compression target chunk 430 that is very similar to a base chunk (which also is a duplicate chunk) 420 in individual data units. In the example depicted in FIG. 3, there are only several bytes of differences in data units (the chunks are displayed as hexadecimal data in the depicted example) between the base chunk 420 and the delta compression target chunk 430. Accordingly, the content volume reduction program 123 takes difference between the base chunk 420 and the delta compression target chunk 430, generates, as a difference chunk 440, the difference along with pointers representing at which positions the pieces of data differ (e.g. [0:8] represents that the chunks have the common first nine pieces of data, and stores the base chunk 420 and the difference chunk 440 on the storage device 240. Hereinafter, when explanations are given about chunks without identifying the states of the chunks, the reference character of duplicate chunks 420 is representatively used to explain them as chunks 420.

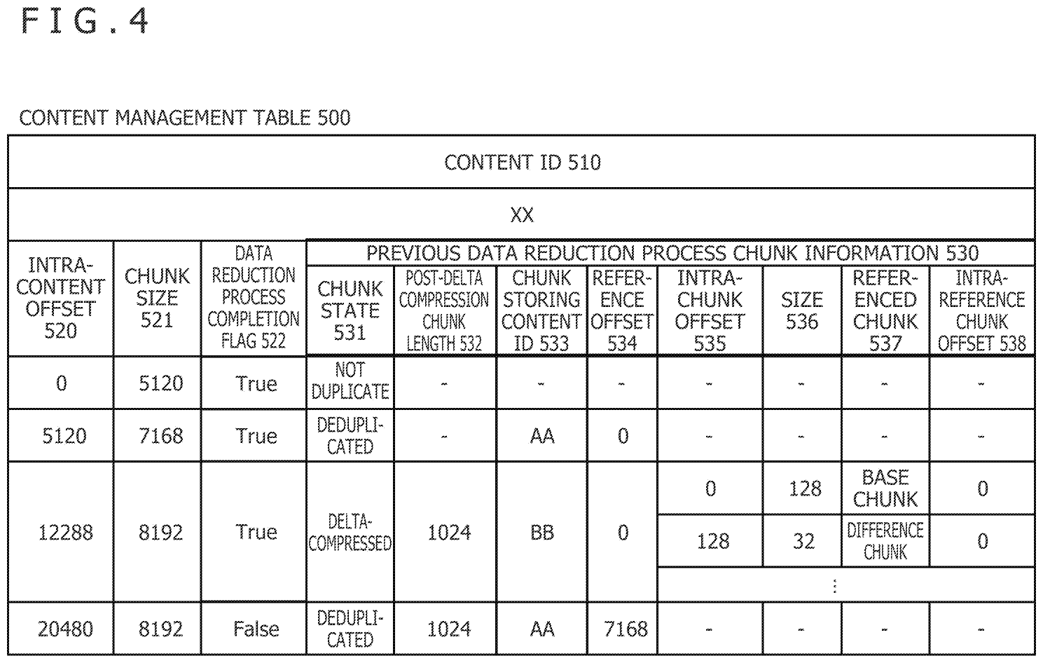

FIG. 4 is a figure depicting an example of the configuration of content management tables 500 of the NAS 10 according to the first embodiment.

The content management tables 500 are an example of structure management data of contents 310, and a content management table 500 is created for each content 310.

A content ID 510 stores an ID that identifies each content 310. Intra-content offsets 520 store offsets, in the content 310, of chunks 420 included in the content 310, that is, values representing at which positions the individual chunks 420 start. Chunk sizes 521 store values representing the sizes of the chunks 420. Data reduction process completion flags 522 store flags representing whether or not the chunks 420 have already been subjected to data amount reduction processes (True represents that a chunk 420 has been subjected to a data amount reduction process, and False represents that a chunk has not been subjected to a data amount reduction process). Since the data reduction process completion flags 522 are updated at chunk updating processes mentioned below, the flags depicted as the data reduction process completion flags 522 represent states of the chunks 420 after being updated.

The content management table 500 has, as previous data reduction process chunk information 530, chunk states 531, post-delta compression chunk lengths 532, chunk storing content IDs 533, reference offsets 534, intra-chunk offsets 535, sizes 536, referenced chunks 537, and intra-reference chunk offsets 538. The previous data reduction process chunk information 530 is information obtained when the previous volume reduction processes by the content volume reduction program 123 are performed.

The chunk states 531 store values representing states of the chunks 420 as results of previous data reduction processes being performed. The post-delta compression chunk lengths 532 store values representing the chunk lengths of the chunks 420 on which delta compression has been performed. The chunk storing content IDs 533 store IDs of contents 310 that store chunks 420 as real data that is to be referenced by the chunks 420 on which a deduplication process or a delta compression process has been performed. The real data chunks 420 are referred to as base chunks or base data, hereinafter. The reference offsets 534 store offsets representing at which positions the base chunks 420 are located in the contents 310 represented by the chunk storing content IDs 533.

The intra-chunk offsets 535, the sizes 536, the referenced chunks 537 and the intra-reference chunk offsets 538 store values about the chunks 420 on which delta compression processes have been performed. The intra-chunk offsets 535 store offsets representing which portions of the chunks 420 include the base chunks 420, and which portions of the chunks 420 include difference chunks 440. The sizes 536 store values representing the data sizes of the portions of the base chunks 420 and the difference chunks 440 which are referenced chunks. The referenced chunks 537 store values representing whether chunks to be referenced are base chunks 420 or difference chunks 440. The intra-reference chunk offsets 538 store offsets representing referenced positions of the referenced base chunks 420 and difference chunks 440.

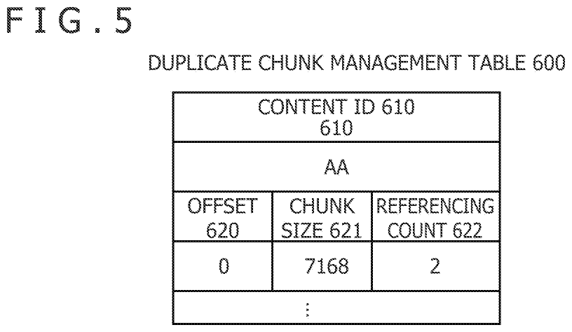

FIG. 5 is a figure depicting an example of the configuration of duplicate chunk management tables 600 of the NAS 10 according to the first embodiment. A duplicate chunk management table 600 is created for each duplicate chunk storing content 320 depicted in FIG. 2.

A content ID 610 stores an ID that identifies a duplicate chunk storing content 320. Offsets 620 store offsets of chunks 420 included in the duplicate chunk storing content 320, that is, values representing at which positions the chunks 420 start. Chunk sizes 621 store values representing the sizes of the chunks 420. Referencing counts 622 store numbers representing how many contents 310 reference the chunks 420 (as depicted in FIG. 2, the duplicate chunk storing content 320 stores duplicate chunks 420).

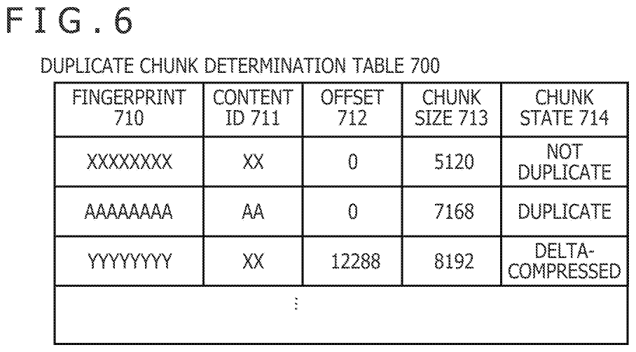

FIG. 6 is a figure depicting an example of the configuration of duplicate chunk determination tables 700 of the NAS 10 according to the first embodiment.

Fingerprints 710 are fixed-length hash values determined from data of individual chunks 420, and it is possible to uniquely identify the chunks 420 by using the fingerprints 710. Content IDs 711 store IDs of contents 310 including the chunks 420. Offsets 712 store values representing at which positions in the contents 310 the chunks 420 start. Chunk sizes 713 store values representing the sizes of the chunks 420. The chunk states 714 store values representing states of the chunks 420 as results of data reduction processes being performed.

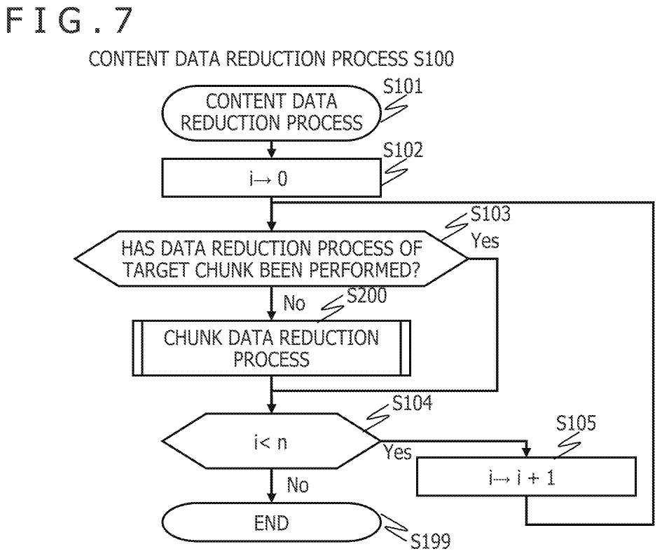

FIG. 7 is a flowchart depicting an example of a content data reduction process of the NAS 10 according to the first embodiment.

The content data reduction process depicted in FIG. 7 is executed at the time of post-processing for each content 310. Although the timing of execution can be any timing, as an example, the processor 110 of the NAS 10 acquires an operation log of contents 310 as appropriate, a content 310 on which an updating process has been performed is identified on the basis of the operation log, and the content data reduction process depicted in FIG. 7 is performed on the content 310 related to the updating. Alternatively, as another example, an update flag whose state changes when an updating process has been performed is provided for each content 310, a content 310 on which an updating process has been performed is identified on the basis of the update flags, and the content data reduction process depicted in FIG. 7 is performed on the content 310 related to the updating.

In FIG. 7, the content volume reduction program 123 initializes a variable i that identifies on which chunk 420 in chunks 420 included in a content 310 on which the content data reduction process is to be performed, the content data reduction process is to be performed (S102).

Next, by referring to the data reduction process completion flags 522 in the content management table 500, the content volume reduction program 123 determines whether or not a data reduction process of a chunk 420 identified by the variable i has been performed (S103). Then, if it is determined that the data reduction process has already been performed (YES at S103), the process proceeds to the S104, and if it is determined that the data amount reduction process has not been performed (in this case, after an updating process of the content 310) (NO at S103), the process proceeds to a subroutine S200. Details of the subroutine S200 (chunk data reduction process) are mentioned below.

At S104, the content volume reduction program 123 determines whether or not the variable i that identifies the target chunk 420 of the content data reduction process is smaller than the total number n of the chunks 420 included in the content 310. Then, if it is determined that the variable i is smaller than the total number n (YES at S104), the process proceeds to S105, and if it is determined that the variable i is not smaller than the total number n (in this case, it is determined that i=n) (NO at S104), the process depicted as the flowchart of FIG. 7 ends.

At S105, the content volume reduction program 123 increments the variable i by 1. Thereafter, the process returns to S103.

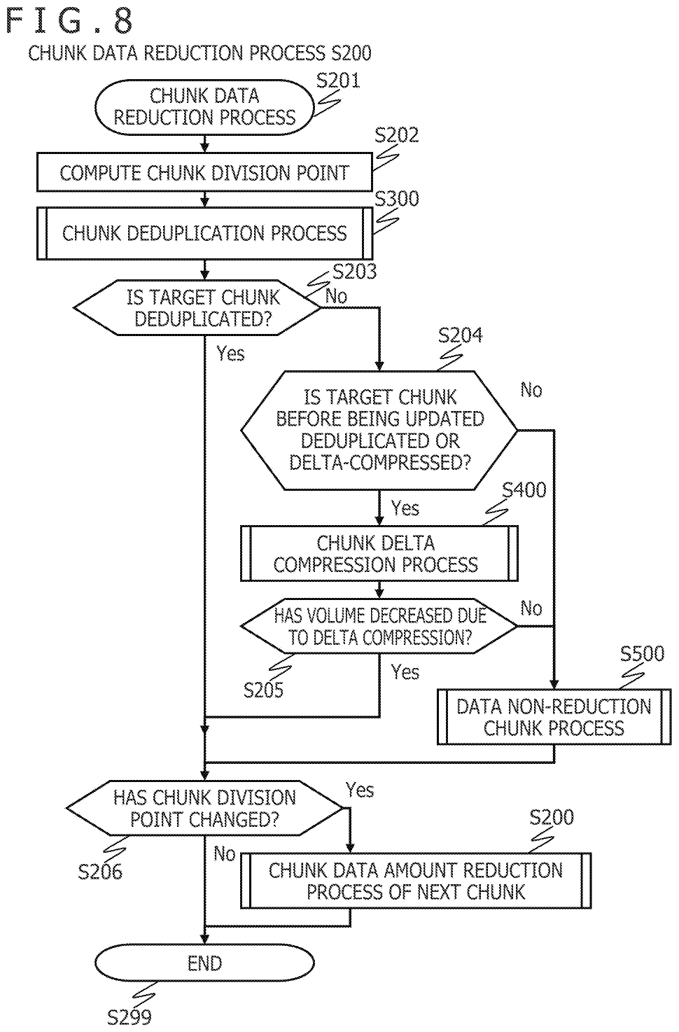

FIG. 8 is a flowchart depicting an example of the chunk data reduction process of the NAS 10 according to the first embodiment.

First, the content volume reduction program 123 computes a division point of a target chunk 420, that is, an offset of the target chunk 420 in a content 310 (S202). This is for checking whether or not there has been a change in the division point of the chunk 420 because the content data reduction process depicted in FIG. 7 is triggered by an updating process of the content 310.

Next, the content volume reduction program 123 executes a subroutine S300 (chunk deduplication process). Details of the chunk deduplication process are mentioned below. Next, by referring to the chunk state 714 in the duplicate chunk determination table 700, the content volume reduction program 123 determines whether or not the target chunk 420 (which has been identified in the content data reduction process in FIG. 7) has been subjected to a deduplication process (S203). Then, if it is determined that the deduplication process has been performed (YES at S203), the process proceeds to S207, and if it is determined that the deduplication process has not been performed (NO at S203) the process proceeds to S204.

At S204, by referring to the chunk state 531 in the content management table 500, the content volume reduction program 123 determines whether or not the target chunk 420 before being updated is deduplicated or delta-compressed. Then, if it is determined that the target chunk 420 before being updated is deduplicated or delta-compressed (YES at S204), a subroutine S400 (chunk delta compression process) is executed, and if it is determined that the target chunk 420 before being updated is neither deduplicated nor delta-compressed (NO at S204), a subroutine S500 (data non-reduction chunk process) is executed. Details of the chunk delta compression process and the data non-reduction chunk process are mentioned below.

When the process in the subroutine S400 ends, the content volume reduction program 123 determines whether or not the delta compression process in the subroutine S400 could reduce the volume of the chunk 420 (S205). Then, if it is determined that the volume of the chunk 420 could be reduced (YES at S205), the process proceeds to S206, and if it is determined that the volume of the chunk 420 could not be reduced (NO at S206), the subroutine S500 is executed.

At S206, on the basis of a result of the calculation at S202, the content volume reduction program 123 determines whether there has been a change in the chunk division point of the target chunk 420. Then, if it is determined that there has been a change in the chunk division point (YES at S206), the subroutine S200 is executed on the next chunk 420, and if it is determined that there have been no changes in the chunk division point (NO at S206), the process depicted in the flowchart of FIG. 8 ends.

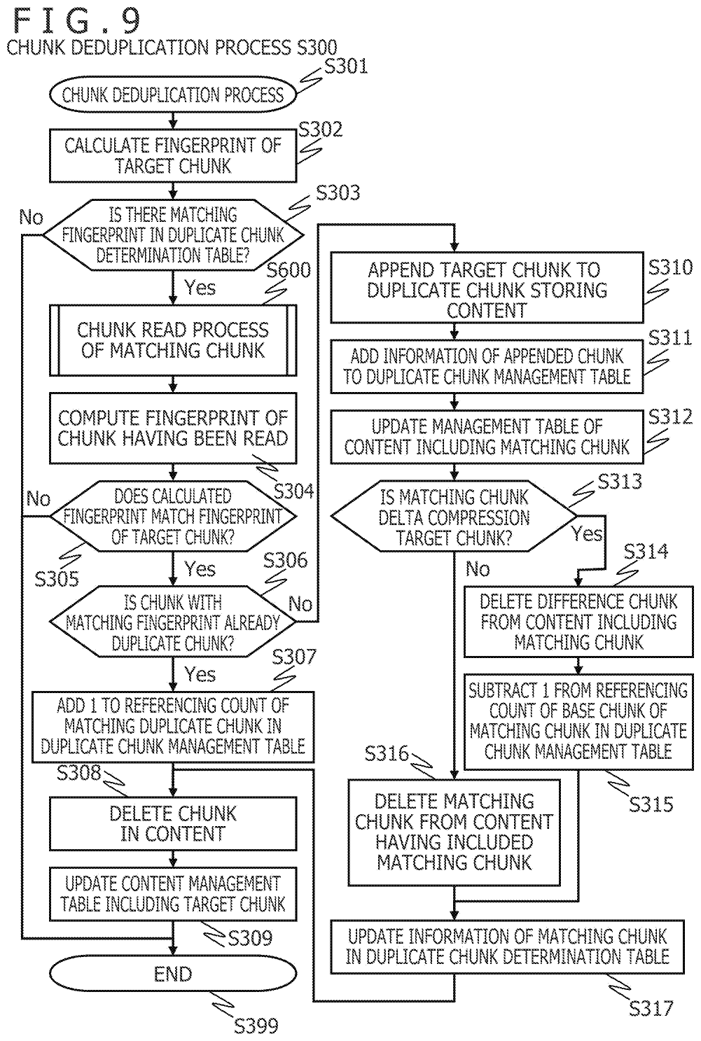

FIG. 9 is a flowchart depicting the chunk deduplication process of the NAS 10 according to the first embodiment.

First, the content volume reduction program 123 calculates a fingerprint of a target chunk 420 (S302). Next, by referring to the fingerprint 710 in the duplicate chunk determination table 700, the content volume reduction program 123 performs a search to find whether or not there is a fingerprint matching the fingerprint calculated at S302 (S303). Then, if it is determined that there is a matching fingerprint (YES at S303), there is a duplicate chunk 420 (or there has been a duplicate chunk 420), and therefore a subroutine S600 (chunk read process) is executed on the matching chunk 420. Details of the chunk read process are mentioned below. On the other hand, if it is determined that there are no matching fingerprints (NO at S303), there are no duplicate chunks 420, and therefore the process depicted in the flowchart of FIG. 9 ends.

After the end of the process in the subroutine S600, the content volume reduction program 123 computes a fingerprint of the chunk read out (read) in the subroutine S600 (S304). Then, the content volume reduction program 123 determines whether or not the fingerprint calculated at S304 matches the fingerprint of the target chunk 420 (S305). Then, if it is determined that the fingerprint calculated at S304 matches the fingerprint of the target chunk 420 (YES at S305), the process proceeds to S306, and if it is determined that the fingerprint calculated at S304 does not match the fingerprint of the target chunk 420 (NO at S306), the process depicted in the flowchart of FIG. 9 ends.

At S306, by referring to the chunk state 714 in the duplicate chunk determination table 700, the content volume reduction program 123 determines whether or not the chunk whose fingerprint matches is already a duplicate chunk 420. Then, if it is determined that the chunk whose fingerprint matches is already a duplicate chunk 420 (YES at S306), the chunk is already managed as a duplicate chunk 420, and therefore the process proceeds to S307. On the other hand, if it is determined that the chunk whose fingerprint matches is not a duplicate chunk 420 (NO at S306), the target chunk 420 has not been subjected to a deduplication process, and therefore the process proceeds to S310 in order to perform a process of moving the target chunk 420 to the duplicate chunk storing content 320.

At S307, the content volume reduction program 123 adds 1 to the referencing count 622 of the matching duplicate chunk 420 in the duplicate chunk management table 600. Next, the content volume reduction program 123 deletes the target chunk 420 in the content 310 (S308). Then, the content volume reduction program 123 updates a content management table 500 including the target chunk 420 (S309), and the process depicted in the flowchart of FIG. 9 ends.

On the other hand, at S310, the content volume reduction program 123 appends the target chunk 420 to the duplicate chunk storing content 320. Next, the content volume reduction program 123 adds information of the appended chunk 420 to the duplicate chunk management table 600 (S311). Furthermore, on the basis of information including the matching chunk 420, the content volume reduction program 123 updates the content management table 500 (S312).

Next, by referring to the chunk state 714 in the duplicate chunk determination table 700, the content volume reduction program 123 determines whether or not the matching chunk 420 is a delta compression target chunk 430 (S313). If it is determined as a result that the matching chunk 420 is a delta compression target chunk 430 (YES at S313), the process proceeds to S314, and if it is determined that the matching chunk 420 is not a delta compression target chunk 430 (NO at S313), the process proceeds to S316.

At S314, the content volume reduction program 123 deletes the difference chunk 440 from the content 310 including the matching chunk 420. Next, the content volume reduction program 123 subtracts 1 from the referencing count 622 of the base chunk 420 of the matching chunk 420 in the duplicate chunk management table 600 (S315).

At S316, the content volume reduction program 123 deletes the matching chunk 420 from the content 310 having included the matching chunk 420. Then, the content volume reduction program 123 updates information of the matching chunk 420 in the duplicate chunk determination table 700 (S317), and the process depicted in the flowchart of FIG. 9 ends.

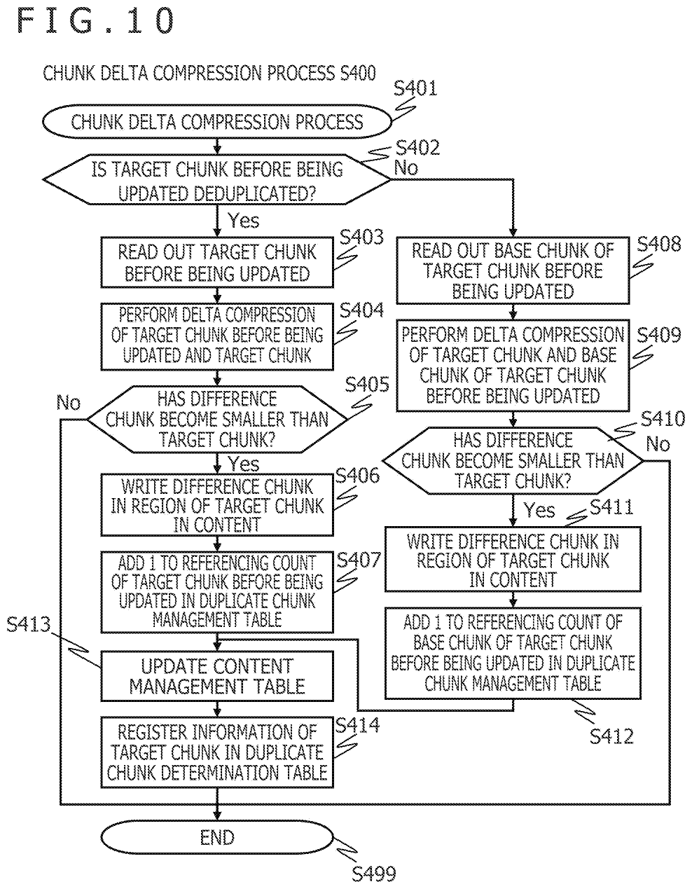

FIG. 10 is a flowchart depicting an example of the chunk delta compression process of the NAS 10 according to the first embodiment.

First, by referring to the chunk state 531 in the content management table 500, the content volume reduction program 123 determines whether or not a target chunk 420 before being updated is deduplicated (S402). Then, if it is determined that the target chunk 420 before being updated is deduplicated (YES at S402), the process proceeds to S403, and if it is determined that the target chunk 420 before being updated is not deduplicated (NO at S402), it is determined that the target chunk 420 before being updated is already deduplicated or delta-compressed (YES at S204), accordingly the target chunk 420 before being updated is delta-compressed, and therefore the process proceeds to S408.

At S403, the content volume reduction program 123 reads out the target chunk 420 before being updated. Next, the content volume reduction program 123 performs a delta compression process between the target chunk 420 before being updated and the target chunk 420 (S404).

The content volume reduction program 123 determines whether or not the volume of the difference chunk 440 has become smaller than (has decreased from) the volume of the target chunk 420 as a result of the delta compression process at S404 (S405). Then, if it is determined that the difference chunk 440 has become smaller than the target chunk 420 (YES at S405), the process proceeds to S406, and if it is determined that the difference chunk 440 has not become smaller than the target chunk 420 (NO at S405), the process depicted in the flowchart of FIG. 10 ends.

At S406, the content volume reduction program 123 writes the difference chunk 440 in a region of the target chunk 420 in the content 310. Next, the content volume reduction program 123 adds 1 to the referencing count 622 of the target chunk 420 before being updated in the duplicate chunk management table 600 (S407). Furthermore, the content volume reduction program 123 updates the content management table 500 (S413), and registers information of the target chunk 420 in the duplicate chunk determination table 700 (S414). Thereafter, the process depicted in the flowchart of FIG. 10 ends.

On the other hand, at S408, the content volume reduction program 123 reads out a base chunk 420 of the target chunk 420 before being updated. Next, the content volume reduction program 123 performs a delta compression process between the target chunk 420 and the base chunk 420 of the target chunk 420 before being updated (S409).

The content volume reduction program 123 determines whether or not the volume of the difference chunk 440 has become smaller than (has decreased from) the volume of the target chunk 420 as a result of the delta compression process at S409 (S410). Then, if it is determined that the difference chunk 440 has become smaller than the target chunk 420 (YES at S410), the process proceeds to S411, and if it is determined that the difference chunk 440 has not become smaller than the target chunk 420 (NO at S410), the process depicted in the flowchart of FIG. 10 ends.

At S411, the content volume reduction program 123 writes the difference chunk 440 in a region of the target chunk 420 in the content 310. Next, the content volume reduction program 123 adds 1 to the referencing count 622 of the base chunk 420 of the target chunk 420 before being updated in the duplicate chunk management table 600 (S412). Thereafter, the process proceeds to S413.

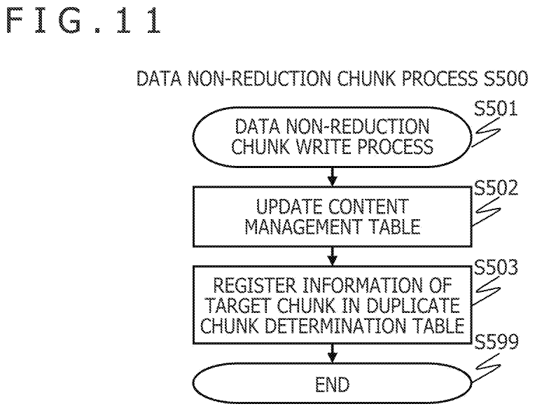

FIG. 11 is a flowchart depicting an example of the data non-reduction chunk process of the NAS 10 according to the first embodiment.

First, the content volume reduction program 123 updates the content management table 500 (S502). Next, the content volume reduction program 123 registers information of a target chunk 420 in the duplicate chunk management table 600 (S503), and the process depicted in the flowchart of FIG. 11 ends.

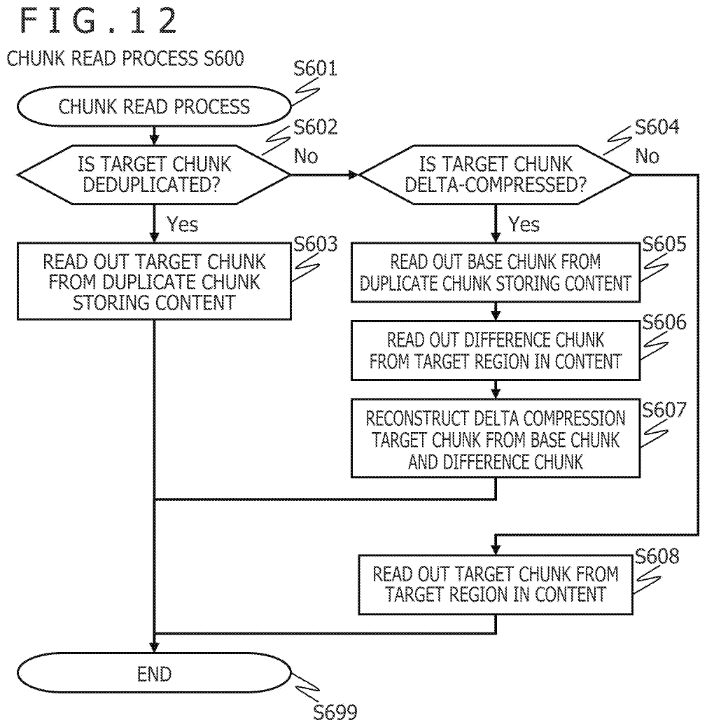

FIG. 12 is a flowchart depicting an example of the chunk read process of the NAS 10 according to the first embodiment. The chunk read process depicted in the flowchart of FIG. 12 is triggered by a read request about a content 310 from the client 11.

First, by referring to the chunk state 714 in the duplicate chunk determination table 700, the content volume reduction program 123 determines whether or not a target chunk 420 which is also the target of the read request is deduplicated (S602). Then, if it is determined that the target chunk 420 is deduplicated (YES at S602), the process proceeds to S603, and if it is determined that the target chunk 420 is not deduplicated (NO at S602), the process proceeds to S604.

At S603, the content volume reduction program 123 reads out the target chunk 420 from the duplicate chunk storing content 320, and the process depicted in the flowchart of FIG. 12 ends.

On the other hand, at S604, by referring to the chunk state 714 in the duplicate chunk determination table 700, the content volume reduction program 123 determines whether or not the target chunk 420 which is the target of the read request is delta-compressed. Then, if it is determined that the target chunk 420 is delta-compressed (YES at S604), the process proceeds to S605, and if it is determined that the target chunk 420 is not delta-compressed (NO at S604), the process proceeds to S608.

At S605, the content volume reduction program 123 reads out the base chunk 420 from the duplicate chunk storing content 320. Next, the content volume reduction program 123 reads out the difference chunk 440 from a target region in the content 310 (S608). Furthermore, the content volume reduction program 123 reconstructs a delta compression target chunk 430 from the base chunk 420 and the difference chunk 440 (S607), and the process depicted in the flowchart of FIG. 12 ends.

At S608, since the target chunk 420 is neither a duplicate chunk 420 nor a difference chunk 440, the content volume reduction program 123 reads out the target chunk 420 from a target region in the content 310, and the process depicted in the flowchart of FIG. 12 ends.

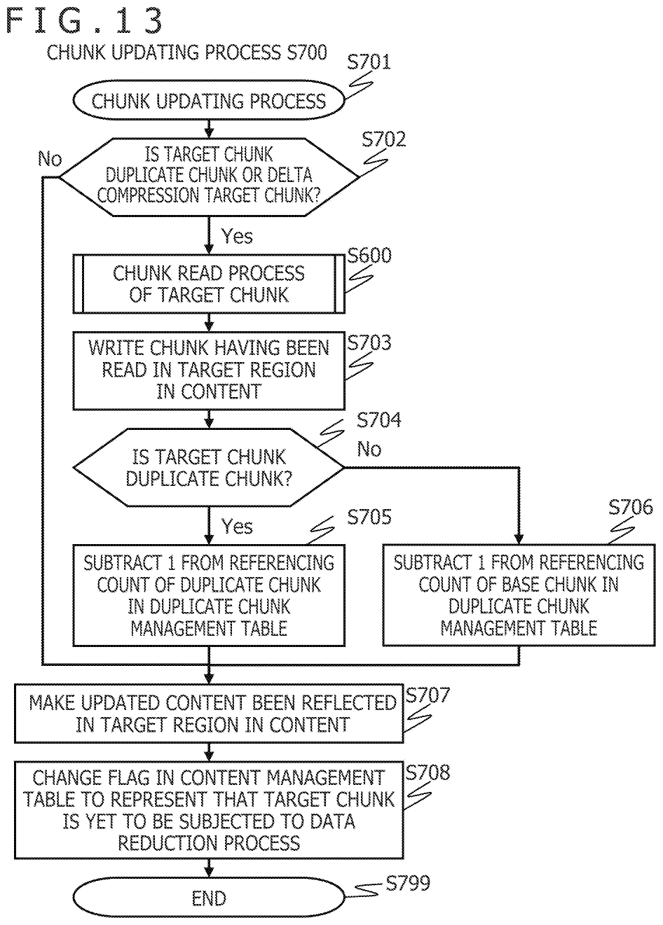

FIG. 13 is a flowchart depicting an example of the chunk updating process of the NAS 10 according to the first embodiment. The chunk updating process depicted in the flowchart of FIG. 13 is triggered by a write request about a content 310 from the client 11.

First, by referring to the chunk state 714 in the duplicate chunk determination table 700, the content volume reduction program 123 determines whether or not a target chunk 420 which is also the target of the write request is a duplicate chunk 420 or a delta compression target chunk 430 (S702). Then, if it is determined that the target chunk 420 is a duplicate chunk 420 or a delta compression target chunk 430 (YES at S702), a read process of the target chunk 420 is performed at the subroutine S600, and if it is determined that the target chunk 420 is not a duplicate chunk 420 or a delta compression target chunk 430 (NO at S702), the process proceeds to S707.

After the chunk read process of the target chunk 420 is performed, the content volume reduction program 123 writes, in a target region in the content 310, the chunk 420 having been read in the subroutine S600 (S703).

Next, by referring to the chunk state 714 in the duplicate chunk determination table 700, the content volume reduction program 123 determines whether or not the target chunk 420 is a duplicate chunk 420 (S704). Then, if it is determined that the target chunk 420 is a duplicate chunk 420 (YES at S704), the process proceeds to S705, and if it is determined that the target chunk 420 is not a duplicate chunk 420 (NO at S701), the process proceeds to S706.

At S705, the content volume reduction program 123 subtracts 1 from the referencing count 622 of the duplicate chunk 420 in the duplicate chunk management table 600. On the other hand, at S706, the content volume reduction program 123 subtracts 1 from the referencing count 622 of the base chunk 420 in the duplicate chunk management table 600.

At S707, the content volume reduction program 123 makes the updated content been reflected in the target region in the content 310. Then, by changing the data reduction process completion flag 522 of the target chunk 420 in the content management table 500 to False, the content volume reduction program 123 clearly indicates that the target chunk 420 is yet to be subjected to a data reduction process (S708), and the process depicted in the flowchart of FIG. 13 ends.

According to the thus-configured present embodiment, it is possible to make it unnecessary to perform a similar data search task in a delta compression process when the delta compression process is performed. Thereby, the storage system by which it is possible to attempt to reduce the processing load can be realized. Furthermore, a data reduction process by a delta compression process can be performed also in a storage system which has not performed a delta compression process in order to avoid the risk of an increase in the processing load, and a further data reduction process can be performed.

### Second Embodiment

While the storage system (NAS 10) to which the first embodiment and the second embodiment are applied changes a target chunk 420 of a delta compression process depending on the situation of data reduction before updating, contents 310 and chunks 420 can be updated as appropriate also during a data reduction process. Because of this, in the present embodiment, the state before the target chunk 420 is updated is grasped appropriately, and an appropriate data reduction process is performed.

Here, the NAS 10 to which the second embodiment is applied is similar to that in the first embodiment. Accordingly, in the following explanation, similar constituent elements are given identical reference characters, and explanations thereof are simplified. In addition, as various types of process not depicted, various types of process of the embodiment explained already are performed.

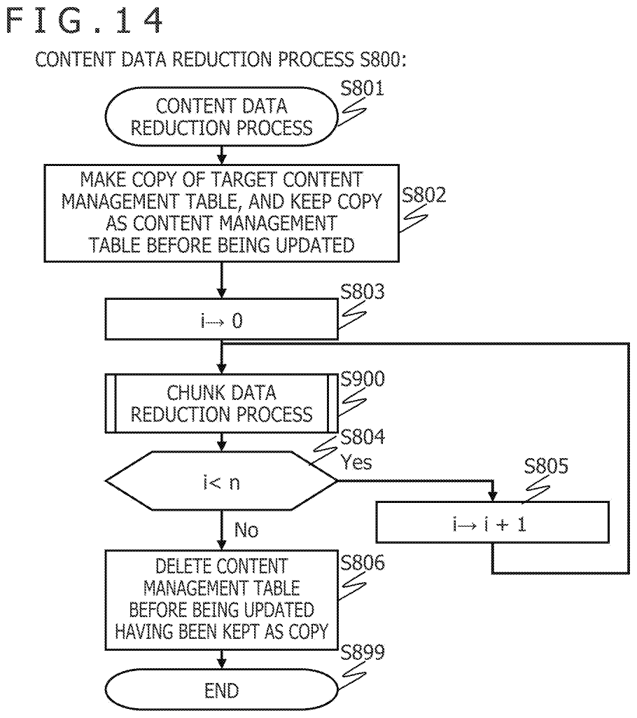

FIG. 14 is a flowchart depicting an example of the content data reduction process of the storage system (NAS 10) according to the second embodiment. The content data reduction process depicted in FIG. 14 is almost identical to the content data reduction process in the first embodiment depicted in FIG. 7.

The difference is that before the content data reduction process is performed, the content volume reduction program 123 keeps, in the memory 120 or the cache 130, a copy of the content management table 500 of a target content 310 as the content management table 500 before being updated (S802), and, after a chunk data reduction process (subroutine S900) is performed on all chunks 420, the content volume reduction program 123 deletes the content management table 500 before being updated that has been kept as the copy (S806).

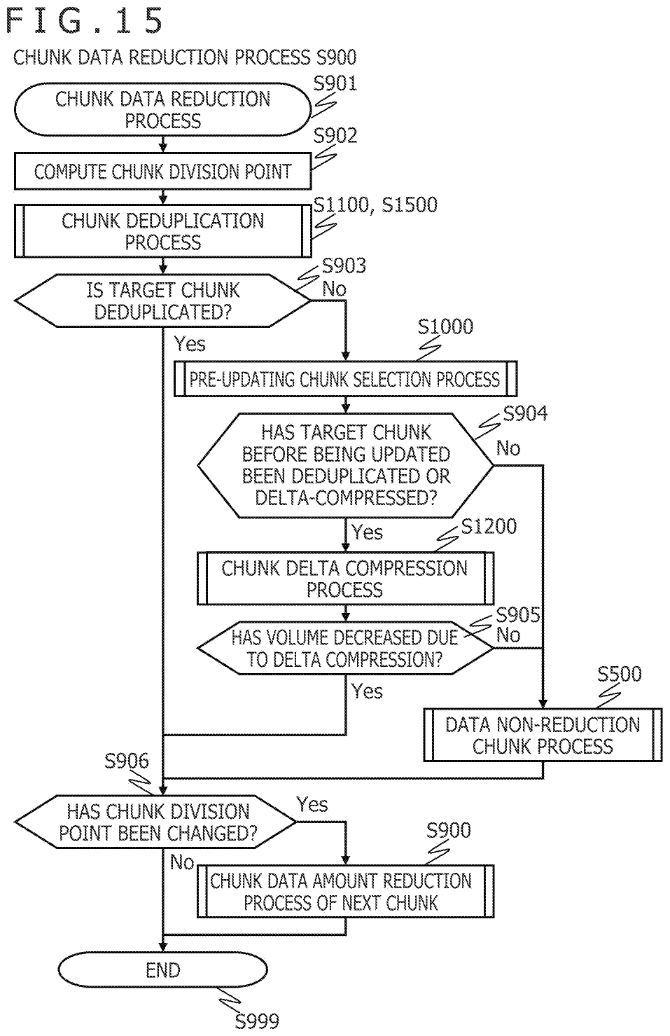

FIG. 15 is a flowchart depicting an example of the chunk data reduction process of the NAS 10 according to the second embodiment. The chunk data reduction process depicted in FIG. 15 is almost the same as the chunk data reduction process in the first embodiment depicted in FIG. 8.

The difference is that details of a chunk deduplication process in a subroutine S1100 (a subroutine S1500 is referred to in a third embodiment) are different (details are mentioned below), and a subroutine S1000 (pre-updating chunk selection process) is performed before a process at S904 in which, by referring to the chunk state 531 in the content management table 500, the content volume reduction program 123 determines whether or not a target chunk 420 before being updated is deduplicated or delta-compressed. Details of the pre-updating chunk selection process are mentioned below.

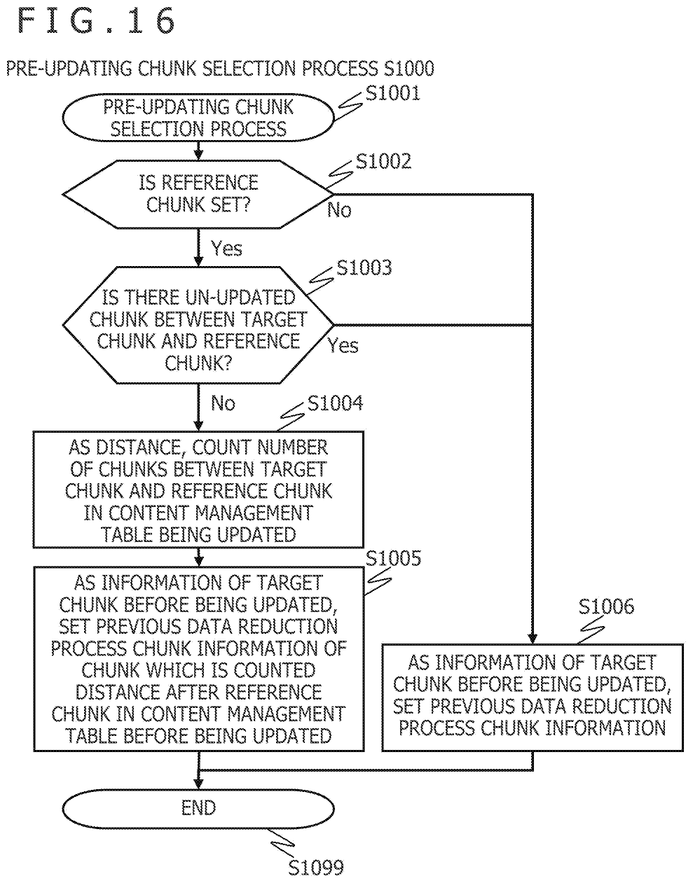

FIG. 16 is a flowchart depicting an example of the pre-updating chunk selection process of the NAS 10 according to the second embodiment.

First, the content volume reduction program 123 determines whether or not a reference chunk 420 is set (S1002). A reference chunk 420 is set at S1109 when a chunk deduplication process S1100 mentioned below is performed or at S1215 when a chunk delta compression process S1200 mentioned below is performed. Setting information is temporarily stored on the memory 120 or the cache 130 of the NAS 10. Then, if it is determined that a reference chunk 420 is set (YES at S1002), the process proceeds to S1003, and if it is determined that a reference chunk 420 is not set (NO at S1002), the process proceeds to S1006.

At S1003, the content volume reduction program 123 determines whether or not there is an un-updated chunk 420 between a target chunk 420 and the set reference chunk 420. This determination is a determination as to whether or not information represented by the content management table 500 has shifted because there has been insertion or deletion of a chunk 420 after the reference chunk 420 during operation of a content data reduction process S800 by the content volume reduction program 123.

Then, if it is determined that there are no un-updated chunks 420 between the target chunk 420 and the set reference chunk 420 (i.e. there is no shifting) (NO at S1003), the process proceeds to S1004, and if it is determined that there is an un-updated chunk 420 between the target chunk 420 and the set reference chunk 420 (i.e. there is shifting) (YES at S1003), the process proceeds to S1006.

At S1004, as the chunk count, the content volume reduction program 123 counts the distance between the target chunk 420 and the reference chunk 420 in the content management table 500 being updated (i.e. currently stored on the storage device 240). Next, as information of the target chunk 420 before being updated, the content volume reduction program 123 sets previous data reduction process chunk information 530 of a chunk 420 which is the distance determined at S1004 after the reference chunk 420 in the content management table 500 before being updated (stored at S802) (S1005), and the process depicted in the flowchart of FIG. 16 ends.

On the other hand, at S1006, as information of the target chunk 420 before being updated, the content volume reduction program 123 sets previous data reduction process chunk information 530 in the content management table 500 being updated (i.e. currently stored on the storage device 240) (S1005), and the process depicted in the flowchart of FIG. 16 ends.

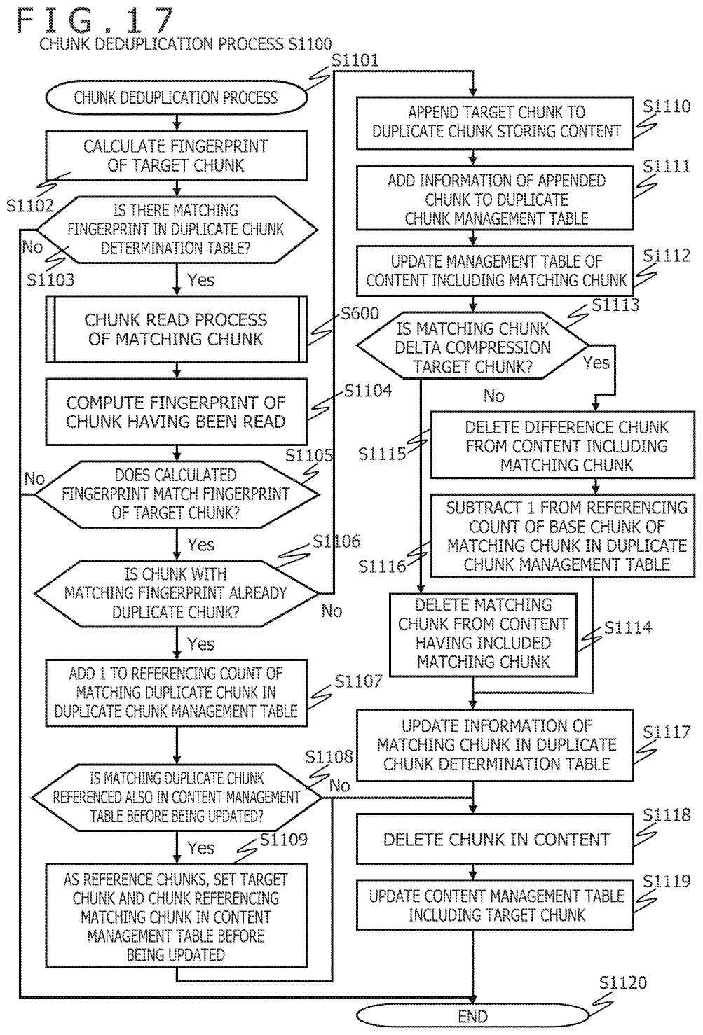

FIG. 17 is a flowchart depicting the chunk deduplication process of the NAS 10 according to the second embodiment. The chunk deduplication process depicted in FIG. 17 is almost the same as the chunk data reduction process in the first embodiment depicted in FIG. 9.

The difference is that S1108 and S1109 are added after the process in which the content volume reduction program 123 adds 1 to the referencing count 622 of the matching duplicate chunk 420 in the duplicate chunk management table 600 (S1107).

That is, at S1108, the content volume reduction program 123 determines whether or not the duplicate chunk 420 whose fingerprint matches is referenced also in the content management table 500 before being updated (stored at S802). Then, if it is determined that the duplicate chunk 420 whose fingerprint matches is referenced also in the content management table 500 before being updated (YES at S1108), the process proceeds to S1109, and if it is determined that the duplicate chunk 420 whose fingerprint matches is not referenced in the content management table 500 before being updated (NO at S1108), the process proceeds to S1118.

At S1109, as reference chunks 420, the content volume reduction program 123 sets the target chunk 420 and the chunk 420 that references the chunk 420 whose fingerprint matches in the content management table 500 before being updated. Thereafter, the process proceeds to S1118.

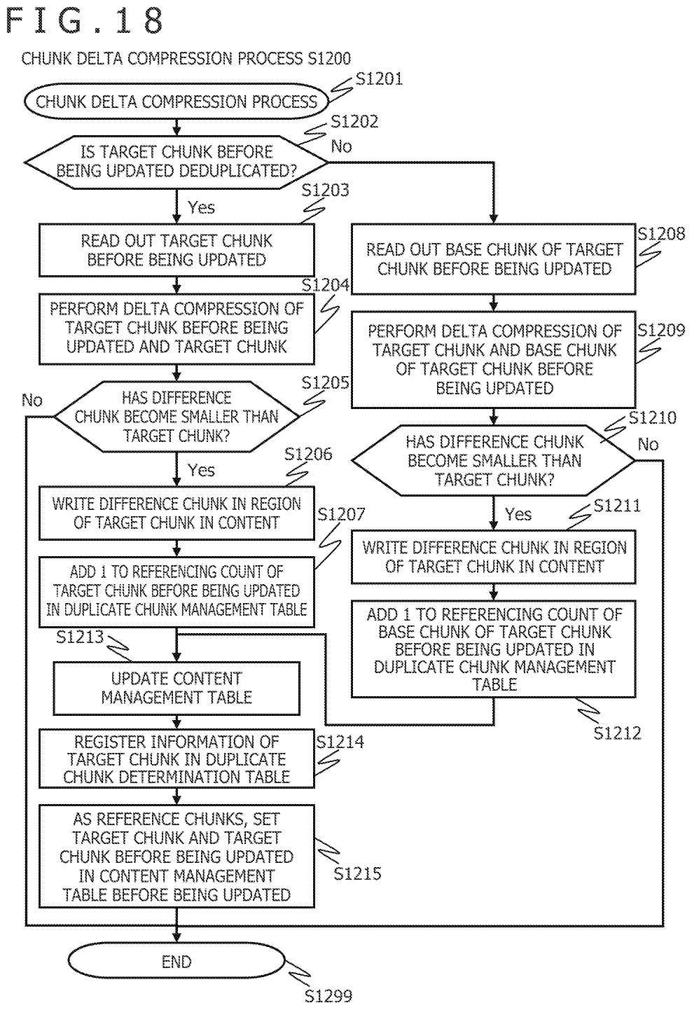

FIG. 18 is a flowchart depicting an example of the chunk delta compression process of the NAS 10 according to the second embodiment. The chunk delta compression process depicted in FIG. 18 is almost the same as the chunk delta compression process in the first embodiment depicted in FIG. 9.

The difference is that, after information of a target chunk 420 is registered in the duplicate chunk determination table 700 (S1214), a process at S1215 is performed.

That is, at S1215, as reference chunks 420, the content volume reduction program 123 sets the target chunk 420 and the chunk 420 before being updated in the content management table 500 before being updated (stored at S802).

Accordingly, according to the present embodiment also, advantages similar to those in the first embodiment mentioned above can be attained.

### Third Embodiment

In a case where the client 11 newly creates a content 310, and stores (makes a write request about) the newly created content 310 on the storage device 240, the client 11 creates the new content 310 by making a copy of another content 310 already stored on the storage device 240 in some cases. The present embodiment makes it possible to simply search for an appropriate chunk 420 before being updated about such a new content 310 created by making a copy of another content 310.

Here, the NAS 10 to which the third embodiment is applied also is similar to that in the first embodiment. In addition, as various types of process not depicted, various types of process in the first embodiment and the second embodiment explained already are performed.

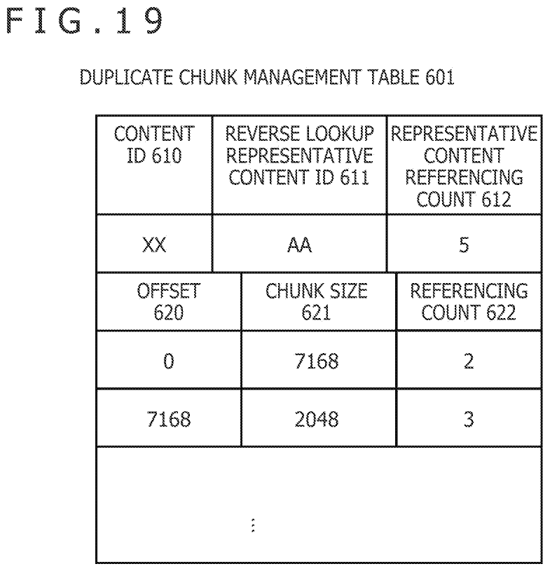

FIG. 19 is a figure depicting an example of the configuration of duplicate chunk management tables 601 of the NAS 10 according to the third embodiment. The duplicate chunk management table 601 in the present embodiment depicted in FIG. 19 additionally has a reverse lookup representative content ID 611 and a representative content referencing count 612, as compared to the duplicate chunk management table 600 in the first embodiment.

The reverse lookup representative content ID 611 stores an ID of a content 310 that is most referenced in a duplicate chunk storing content 320. The representative content referencing count 612 is the number of times the content 310 identified by the reverse lookup representative content ID 611 is referenced. These reverse lookup representative content ID 611 and representative content referencing count 612 are input in advance, and can be updated as appropriate in a process mentioned below.

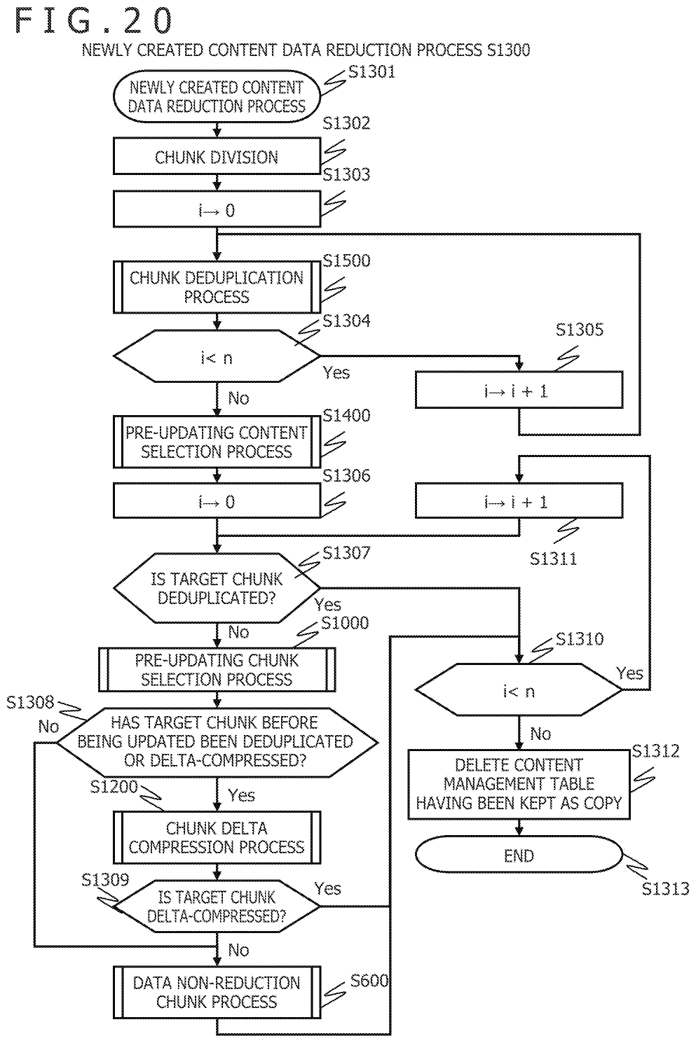

FIG. 20 is a flowchart depicting an example of a newly created content data reduction process of the NAS 10 according to the third embodiment. The newly created content data reduction process depicted in the flowchart of FIG. 20 is started by being triggered when a content 310 is newly created by the client 11, and stored on the storage device 240.

First, the content volume reduction program 123 divides the newly created content 310 into chunks 420 (S1302). A technique for division into chunks 420 is known, therefore an explanation is omitted here.

Next, the content volume reduction program 123 initializes the variable i that identifies which chunk 420 in the chunks 420 included in the newly created content 310 is to be subjected to a deduplication process (S1303), and performs a deduplication process of the target chunk 420 by executing the subroutine S1500 on the target chunk 420.

After the deduplication process in the subroutine S1500, the content volume reduction program 123 determines whether or not the variable i that identifies the target chunk 420 to be subjected to a deduplication process is smaller than the total number n of the chunks 420 included in the content 310 (S1304). Then, if it is determined that the variable i is smaller than the total number n (YES at S1304), the process proceeds to S1305, and if it is determined that the variable i is not smaller than the total number n (in this case, it is determined that i=n) (NO at S1304), a pre-updating content selection process depicted as a subroutine S1400 is executed. The pre-updating content selection process is for performing a delta compression process with a chunk 420 that shares as many duplicates as possible.

At S1305, the content volume reduction program 123 increments the variable i by 1. Thereafter, the process returns to the subroutine S1500.

After the pre-updating content selection process in the subroutine S1400, the content volume reduction program 123 initializes the variable i that identifies which chunk 420 is to be subjected to a delta compression process and the like (S1306), and next determines whether or not the target chunk 420 identified by the variable i is deduplicated (S1307). Then, if it is determined that the target chunk 420 is deduplicated (YES at S1307), the pre-updating chunk selection process depicted as the subroutine S1000 is performed, and if it is determined that the target chunk 420 is not deduplicated (NO at S1307), the process proceeds to S1310.

After the pre-updating chunk selection process in the subroutine S1000, the content volume reduction program 123 determines whether or not the target chunk 420 before being updated is deduplicated or delta-compressed (S1308). Then, if it is determined that the target chunk 420 before being updated is deduplicated or delta-compressed (YES at S1308), a chunk delta compression process (see FIG. 18) depicted as a subroutine S1200 is executed, and if it is determined that the target chunk 420 before being updated is neither deduplicated nor delta-compressed (NO at S1308), the data non-reduction chunk process depicted as the subroutine S600 is executed (see FIG. 11).

After the execution of the chunk delta compression process in the subroutine S1200, the content volume reduction program 123 determines whether or not the target chunk 420 is delta-compressed (S109). Then, if it is determined that the target chunk 420 is delta-compressed (YES at S1309), the process proceeds to S1310, and if it is determined that the target chunk 420 has not been subjected to a delta compression process (NO at S1309), the data non-reduction chunk process depicted as the subroutine S600 is executed. After the execution of the data non-reduction chunk process depicted as the subroutine S600, the process proceeds to S1310.

At S1310, the content volume reduction program 123 determines whether or not the variable i that identifies the target chunk 420 to be subjected to a delta compression process and the like is smaller than the total number n of the chunks 420 included in the content 310. Then, if it is determined that the variable i is smaller (YES at S1310), the process proceeds to S1311, and the content volume reduction program 123 increments the variable i by 1. Thereafter, the process returns to S1307. On the other hand, if it is determined that the variable i is not smaller (a determination that i=n in this case) (NO at S1310), the content volume reduction program 123 deletes the content management table 500 that has been kept as a copy (S1312), and the process depicted in the flowchart of FIG. 20 ends.

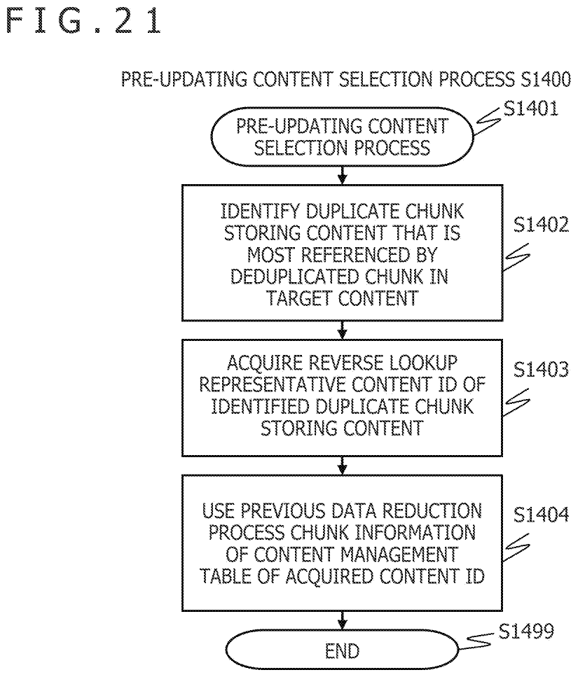

FIG. 21 is a flowchart depicting an example of the pre-updating content selection process of the NAS 10 according to the third embodiment.

First, the content volume reduction program 123 identifies a duplicate chunk storing content 320 that is most referenced by deduplicated chunks 420 in a target content 310 (S1402). Next, the content volume reduction program 123 refers to the duplicate chunk management table 601, and acquires a reverse lookup representative content ID 611 of the duplicate chunk storing content 320 identified at S1402 (S1403). Then, the content volume reduction program 123 uses previous data reduction process chunk information 530 in a content management table 500 of a content 310 identified by the acquired reverse lookup representative content ID 611 (S1404).

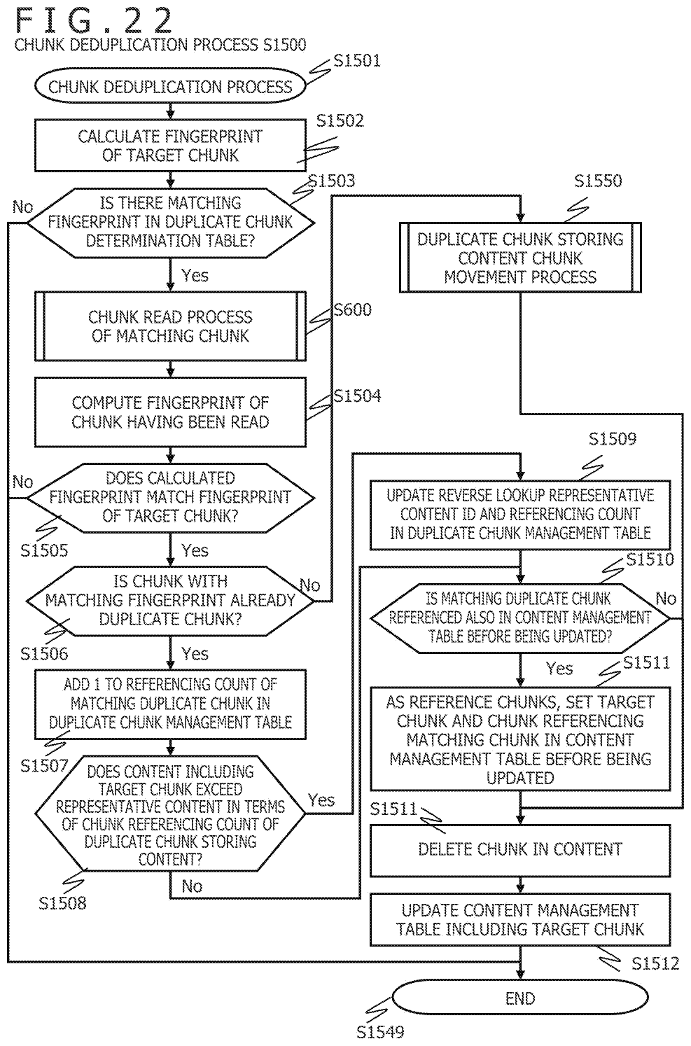

FIG. 22 is a flowchart depicting the chunk deduplication process of the NAS 10 according to the third embodiment. The chunk deduplication process depicted in the flowchart of FIG. 22 additionally has a task of moving newly created content data to a duplicate chunk storing content 320, as compared to the chunk deduplication process in the second embodiment depicted in the flowchart of FIG. 17.

In the flowchart of FIG. 22, S1502 to S1506 are the same as S1102 to S1106 in the flowchart of FIG. 17. Note that a determination at S1506 as to whether or not a chunk 420 whose fingerprint matches is already a duplicate chunk 420 is a determination as to whether a duplicate chunk 420 that has already been generated has been moved (YES at S1506) or has not yet been moved (NO at S1506) to a duplicate chunk storing content 320.

If it is determined that the chunk 420 whose fingerprint matches is already a duplicate chunk 420 (YES at S1506), the content volume reduction program 123 determines whether or not the content 310 including the target chunk 420 exceeds the representative content referencing count 612 of a representative content 310 in terms of the chunk referencing count of the duplicate chunk storing content 320 (S1508). Then, if it is determined that the content 310 exceeds (YES at S1508), the process proceeds to S1509, and if it is determined that the content 310 does not exceed (NO at S1508), the process proceeds to S1510.

On the other hand, if it is determined that the chunk 420 whose fingerprint matches is not already a duplicate chunk 420 (NO at S1506), the process proceeds to a subroutine S1550 (duplicate chunk storing content chunk movement process).

At S1509, the content volume reduction program 123 updates the reverse lookup representative content ID 611 and the referencing count 622 in the duplicate chunk management table 601 with the ID and the referencing count of the content 310 including the target chunk 420. S1510 to S1512 are the same as S1108 to S1109 and S1118 to S1119 in FIG. 17.

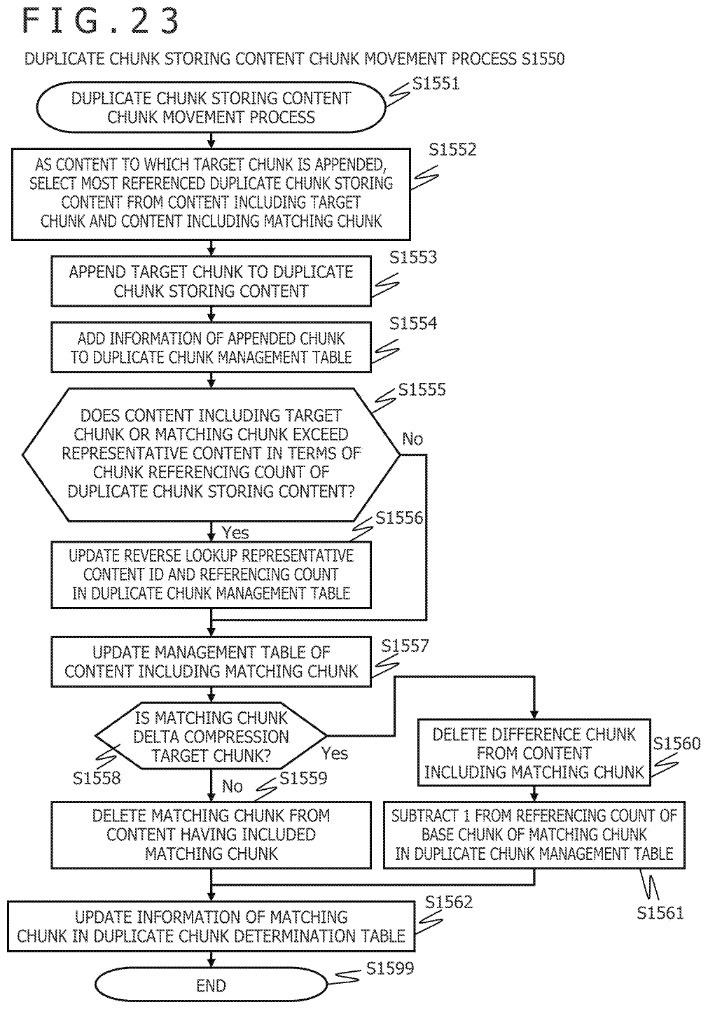

FIG. 23 is a flowchart depicting the duplicate chunk storing content chunk movement process of the NAS 10 according to the third embodiment. The duplicate chunk storing content chunk movement process depicted in the flowchart of FIG. 23 is almost the same as S1110 to S1117 in the chunk deduplication process depicted in the flowchart of FIG. 17.

The difference is S1552, S1555, and S1556. That is, as a content to which the chunk 420 is appended, the content volume reduction program 123 selects a most referenced duplicate chunk storing content 320 from a content 310 including a target chunk 420 and a content 310 including a matching chunk 420 (S1552). That is, a task for aggregation at a duplicate chunk storing content 320 having a referencing count which is as large as possible is performed.

In addition, the content volume reduction program 123 determines whether or not the content 310 including the target chunk 420 or including the matching chunk 420 exceeds the representative content referencing count 612 of the representative content 310 in terms of the chunk referencing count of the duplicate chunk storing content 320 (S1555). Then, if it is determined that the content 310 exceeds the representative content referencing count 612 (YES at S1555), the process proceeds to S1556, and if it is determined that the content 310 does not exceed the representative content referencing count 612 (NO at S1555), the process proceeds to S1557.

At S1556, the content volume reduction program 123 updates the reverse lookup representative content ID 611 and the referencing count 622 in the duplicate chunk management table 601 with the ID and the referencing count of the content 310 including the target chunk 420 or the matching chunk 420.

Accordingly, according to the present embodiment also, advantages similar to those in the second embodiment mentioned above can be attained.

### Fourth Embodiment

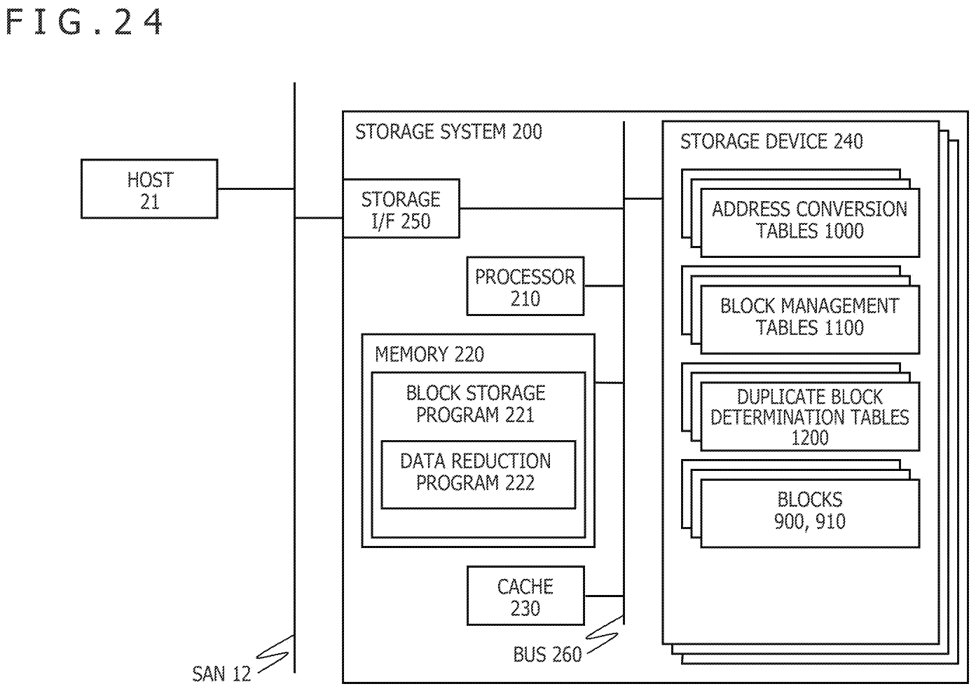

FIG. 24 is a block diagram depicting the schematic configuration of the storage system according to a fourth embodiment.

The present embodiment is applied to a so-called block storage system. A host 21 accesses the storage system 200 via a storage area network (SAN) 22.

The schematic configuration of the storage system 200 is approximately identical to that of the storage system 200 in the first embodiment. In the present embodiment, a data reduction program 222 is included in a block storage program 221 in the memory 220 of the storage system 200. In addition, the storage device 240 of the storage system 200 stores address conversion tables 1000, block management tables 1100, duplicate block determination tables 1200 and blocks 900 and 910. Details of the address conversion tables 1000, the block management tables 1100, and the duplicate block determination table 1200 are mentioned below.

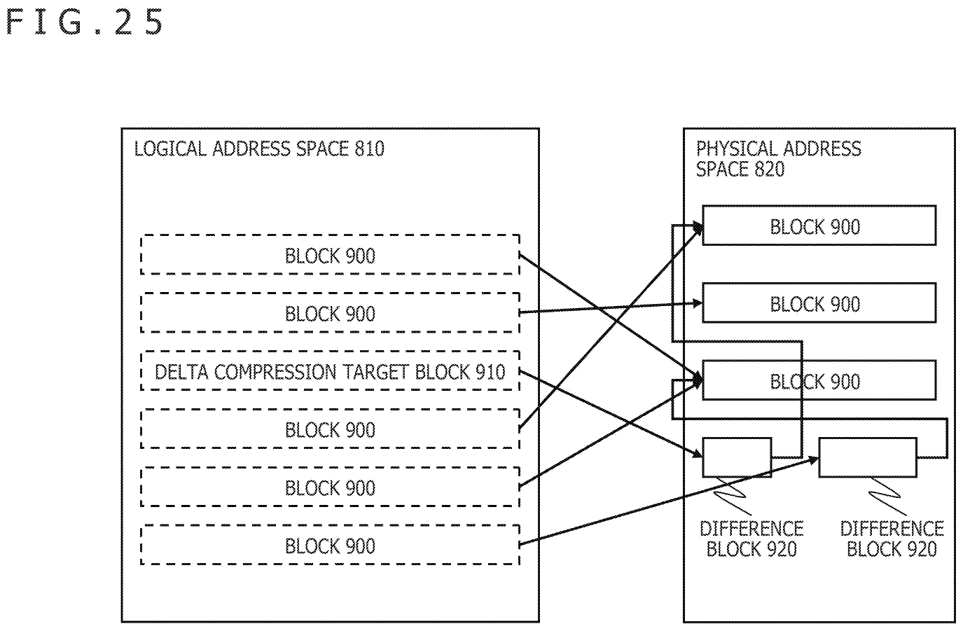

FIG. 25 is a figure depicting an example of the configuration of data stored on the storage system 200 according to the fourth embodiment.

The storage system 200 in the present embodiment stores a file which is a data unit of operation by the host 21 on the storage system 200 in a form divided into a plurality of data units. In the fourth embodiment (and a fifth embodiment mentioned below), a file is stored on the storage system 200 in a form divided into blocks 900 whose data lengths are fixed lengths. At this time, the data reduction program 222 performs a deduplication process and a delta compression process on the blocks 900 and 910.

The block storage program 221 provides a logical address space 810 to the host 21, and the host 21 performs operation of a file in the logical address space 810. Real data of the file is located in a physical address space 820. The file is divided into the fixed-length blocks 900. The blocks 900 on the logical address space 810 and the blocks 900 on the physical address space 820 are associated with each other by a conversion table mentioned below.

In the storage system 200 in the present embodiment also, the data reduction program 222 performs a data reduction process by performing a deduplication process and a delta compression process. The blocks 900 on the physical address space 820 are referenced by a plurality of the blocks 900 on the logical address space 810 in some cases, and thereby the deduplication processes are performed. In addition, a delta compression target block 910 on the logical address space 810 is associated with a block 900 and a difference block 920 which is a result of a delta compression process on the physical address space 820.

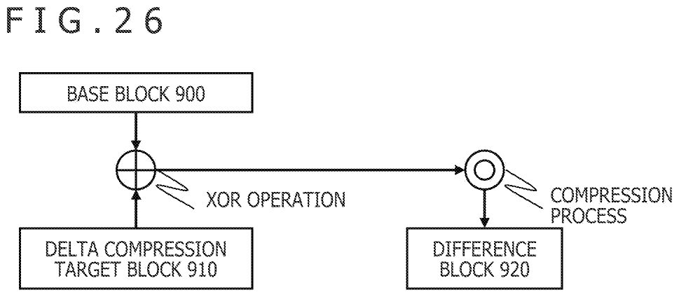

FIG. 26 is a figure for explaining an example of a block data delta compression process.

An exclusive OR (XOR) operation is performed between a base block 900 and a delta compression target block 910. Regarding portions that are the same bitwise in the base block 900 and the delta compression target block 910, 0 is output as a result of the XOR operation, and therefore the data volume of a difference block 920 can be reduced by performing an appropriate compression process.

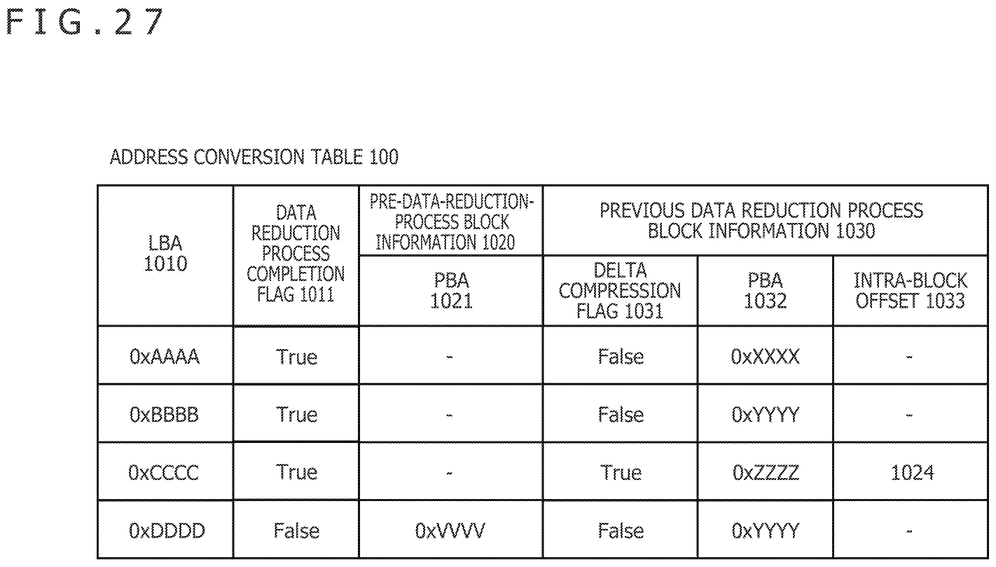

FIG. 27 is a figure depicting an example of the configuration of address conversion tables 1000 of the storage system 200 according to the fourth embodiment.

The address conversion table 1000 is an example of file structure management data, and each line in the address conversion table 1000 corresponds to an individual block 900 on the logical address space 810.

Logical block addresses (LBAs) 1010 store the values of addresses of the blocks 900 on the logical address space 810. Data reduction process completion flags 1011 store flags representing whether or not the blocks 900 have already been subjected to data amount reduction processes (True represents that a block 900 has been subjected to a data amount reduction process, and False represents that a block 900 has not been subjected to a data amount reduction process).

The address conversion table 1000 has physical block addresses (PBAs) 1021 as pre-data-reduction-process block information 1020. The PBAs 1021 store physical addresses of the blocks 900 identified by the LBAs 1010 on the physical address space 820.

In addition, as previous data reduction process block information 1030, the address conversion table 1000 stores delta compression flags 1031, PBAs 1032 and intra-block offsets 1033. The previous data reduction process block information 1030 is information having been obtained when the previous volume reduction processes by the data reduction program 222 are performed.

The delta compression flags 1031 are flags representing whether or not delta compression processes have been performed by the data reduction program 222 in the previous volume reduction processes. If a delta compression process has been performed, True is stored, and if a delta compression process has not been performed, False is stored. The PBAs 1032 store physical addresses of the blocks 900 identified by the LBAs 1010 on the physical address space 820. The intra-block offsets 1033 store offsets representing at which positions in delta compression target blocks 910 difference blocks 920 are located.

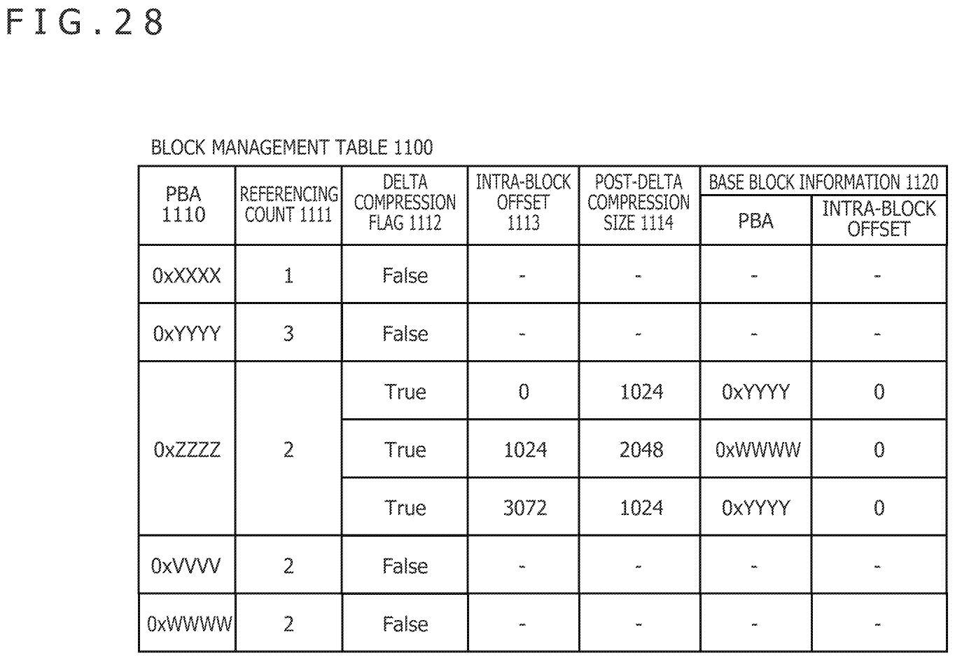

FIG. 28 is a figure depicting an example of the configuration of block management tables 1100 of the storage system 200 according to the fourth embodiment. A block management table 1100 is created for each of the blocks 900 and 920 on the physical address space 820.

PBAs 1110 store physical addresses of the blocks 900 on the physical address space 820. Referencing counts 1111 store numbers representing by how many blocks 900 on the logical address space 810 blocks 900 identified by the PBAs 1110 are referenced. Delta compression flags 1112 are flags representing whether or not the blocks 900 identified by the PBAs 1110 have been subjected to delta compression processes. If a delta compression process has been performed, True is stored, and if a delta compression process has not been performed, False is stored.

Intra-block offsets 1113, post-delta compression sizes 1114 and base block information 1120 are columns that are applied only to difference blocks 920. The intra-block offsets 1033 store offsets representing at which positions delta compression data included in the difference blocks 920 starts. The post-delta compression sizes 1114 store values representing the sizes of the delta compression data included in the difference blocks 920 after delta compression processes. The base block information 1120 stores values related to target base blocks 900 used for delta compression processes of the difference blocks 920, the PBAs store physical addresses of the base blocks 900, and the intra-block offsets store offsets of the base blocks 900.

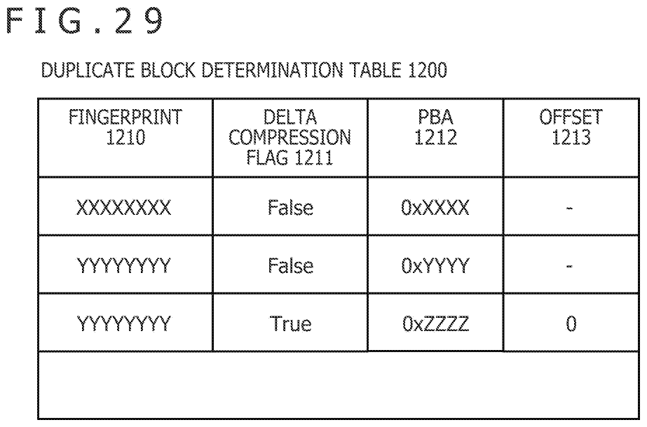

FIG. 29 is a figure depicting an example of the configuration of duplicate block determination tables 1200 of the storage system 200 according to the fourth embodiment. A duplicate block determination table 1200 is created for each of the blocks 900 on the physical address space 820.

Fingerprints 1210 are fixed-length hash values determined from data of individual blocks 900, and it is possible to uniquely identify the blocks 900 by using the fingerprints 1210. Delta compression flags 1211 are flags representing whether or not the blocks 900 identified by the PBAs 1212 have been subjected to delta compression processes. If a delta compression process has been performed, True is stored, and if a delta compression process has not been performed, False is stored. PBAs 1212 store physical addresses of the blocks 900 on the physical address space 820. Offsets 1213 store offsets of the blocks 900.

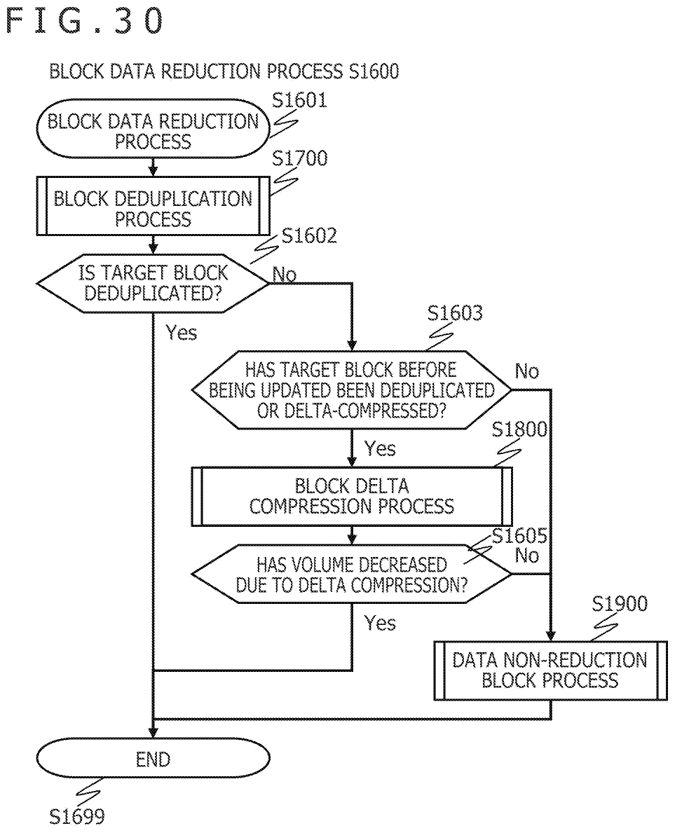

FIG. 30 is a flowchart depicting an example of a block data reduction process of the storage system 200 according to the fourth embodiment.

In the present embodiment and the fifth embodiment mentioned below, the block data reduction process depicted in FIG. 30 is executed for each block 900 at the time of post-processing. The data reduction program 222 performs the data reduction process for each block 900. Although the timing of execution can be any timing, as an example, the processor 210 of the storage system 200 acquires an operation log of files as appropriate, a file on which an updating process has been performed is identified on the basis of the operation log, and the block data reduction process depicted in FIG. 30 is performed on the block 900 related to the updating. Alternatively, as another example, an update flag whose state changes when an updating process has been performed is provided for each file, a file on which an updating process has been performed is identified on the basis of the update flags, and the file data reduction process depicted in FIG. 30 is performed on the block 900 related to the updating.

First, the data reduction program 222 executes a subroutine S1700 (block deduplication process). Details of the block deduplication process are mentioned below. Next, by referring to the referencing count 1111 in the block management table 1100, the data reduction program 222 determines whether or not a target block 900 has been subjected to a deduplication process (S1602). Then, if it is determined that the deduplication process has been performed (YES at S1602), the process depicted in the flowchart of FIG. 30 ends, and if it is determined that the deduplication process has not been performed (NO at S1602) the process proceeds to S1603.

At S1603, by referring to the address conversion table 1000, the data reduction program 222 determines whether or not the target block 900 before being updated is deduplicated or delta-compressed. Then, if it is determined that the target block 900 before being updated is deduplicated or delta-compressed (YES at S1603), a subroutine S1800 (block delta compression process) is executed, and if it is determined that the target block 900 before being updated is neither deduplicated nor delta-compressed (NO at S1603), a subroutine S1900 (data non-reduction block process) is executed. Details of the block delta compression process and the data non-reduction block process are mentioned below.

When the process in the subroutine S1800 ends, the data reduction program 222 determines whether or not the delta compression process in the subroutine S1800 could reduce the volume of the block 900 (S1605). Then, if it is determined that the volume of the block 900 could be reduced (YES at S1605), the process depicted in the flowchart of FIG. 30 ends, and if it is determined that the volume of the block 900 could not be reduced (NO at S1605), the subroutine S1900 is executed. Thereafter, the process depicted in the flowchart of FIG. 30 ends.

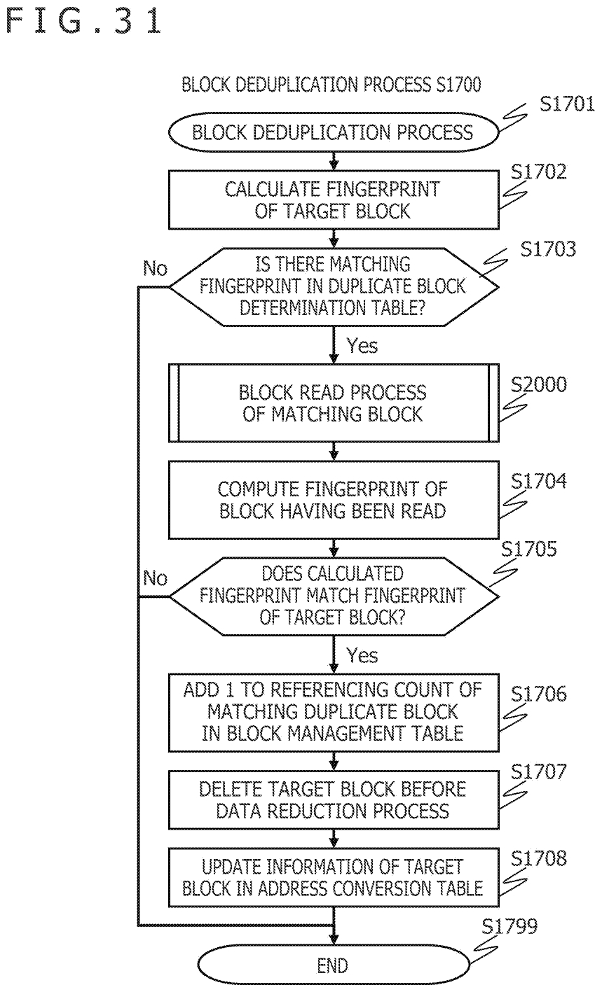

FIG. 31 is a flowchart depicting the block deduplication process of the storage system 200 according to the fourth embodiment.

First, the data reduction program 222 calculates a fingerprint of a target block 900 (S1702). Next, by referring to the fingerprint 1210 in the duplicate block determination table 1200, the data reduction program 222 performs a search to find whether or not there is a fingerprint matching the fingerprint calculated at S1702 (S1703). Then, if it is determined that there is a matching fingerprint (YES at S1703), there is a duplicate block 900, and therefore a subroutine S2000 (block read process) is executed on the matching block 900. Details of the block read process are mentioned below. On the other hand, if it is determined that there are no matching fingerprints (NO at S1703), there are no duplicate blocks 900, and therefore the process depicted in the flowchart of FIG. 31 ends.

After the end of the process in the subroutine S2000, the data reduction program 222 computes a fingerprint of the block 900 read out (read) in the subroutine S2000 (S1704). Then, the data reduction program 222 determines whether or not the fingerprint calculated at S1704 matches the fingerprint of the target block 900 (S1705). Then, if it is determined that the fingerprint calculated at S1704 matches the fingerprint of the target block 900 (YES at S1705), the process proceeds to S1706, and if it is determined that the fingerprint calculated at S1704 does not match the fingerprint of the target block 900 (NO at S1706), the process depicted in the flowchart of FIG. 31 ends.

At S1706, the data reduction program 222 adds 1 to the referencing count 1111 of the matching duplicate block 900 in the block management table 1100. Next, the data reduction program 222 deletes the target block 900 before being subjected to a data reduction process (S1707). Then, the data reduction program 222 updates information of the target block 900 in the address conversion table 1000 (S1708), and the process depicted in the flowchart of FIG. 9 ends.

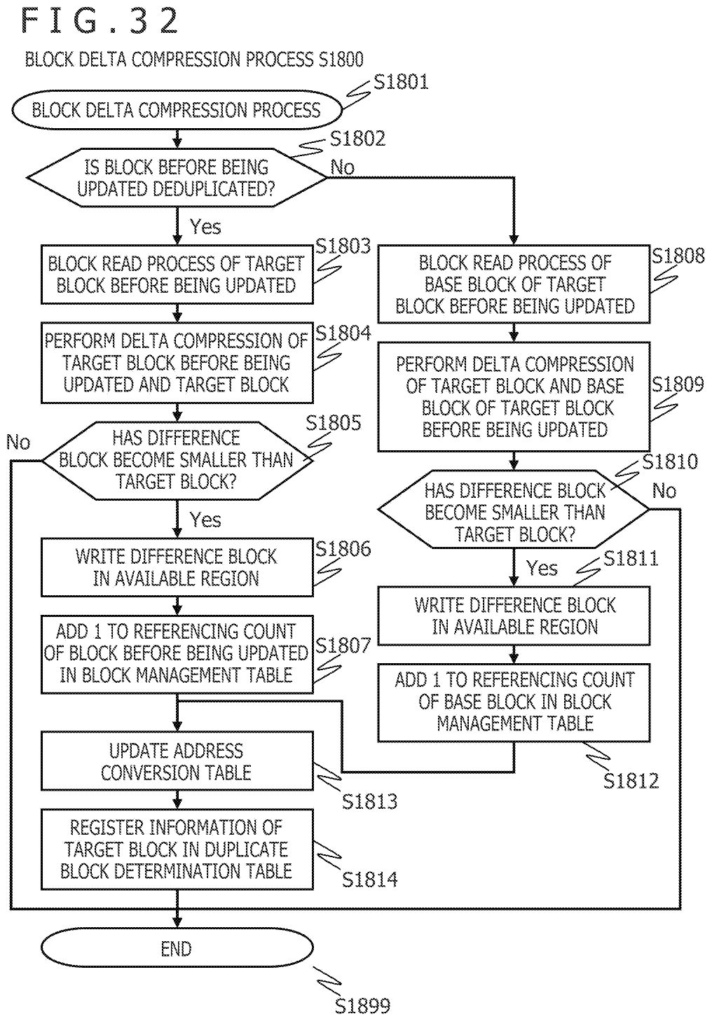

FIG. 32 is a flowchart depicting an example of the block delta compression process of the storage system 200 according to the fourth embodiment.

First, by referring to the data reduction process completion flag 1011 in the address conversion table 1000, the data reduction program 222 determines whether or not a target block 900 before being updated is deduplicated (S1802). Then, if it is determined that the target block 900 before being updated is deduplicated (YES at S1802), the process proceeds to S1803, and if it is determined that the target block 900 before being updated is not deduplicated (NO at S1802), it is determined that the target block 900 before being updated is already deduplicated or delta-compressed (YES at S1802), accordingly the target block 900 before being updated is delta-compressed, and therefore the process proceeds to S1808.

At S1803, the data reduction program 222 reads out the target block 900 before being updated. Next, the data reduction program 222 performs a delta compression process between the target block 900 before being updated and the target block 900 (S1804).

The data reduction program 222 determines whether or not the volume of the difference block 920 has become smaller than (decreased from) the volume of the target block 900 as a result of the delta compression process at S1804 (S1805). Then, if it is determined that the difference block 920 has become smaller than the target block 900 (YES at S1805), the process proceeds to S1806, and if it is determined that the difference block 920 has not become smaller than the target block 900 (NO at S1805), the process depicted in the flowchart of FIG. 32 ends.

At S1806, the data reduction program 222 writes the difference block 920 in an available region in the storage device 240. Next, the data reduction program 222 adds 1 to the referencing count 1111 of the target block 900 before being updated in the block management table 1100 (S1807). Furthermore, the data reduction program 222 updates the address conversion table 1000 (S1813), and registers information of the target block 900 in the duplicate block determination table 1200 (S1814). Thereafter, the process depicted in the flowchart of FIG. 10 ends.

On the other hand, at S1808, the data reduction program 222 reads out the base block 900 of the target block 900 before being updated. Next, the data reduction program 222 performs a delta compression process between the target block 900 and the base block 900 of the target block 900 before being updated (S1809).

The data reduction program 222 determines whether or not the volume of the difference block 920 has become smaller than (decreased from) the volume of the target block 900 as a result of the delta compression process at S1809 (S1810). Then, if it is determined that the difference block 920 has become smaller than the target block 900 (YES at S1810), the process proceeds to S1811, and if it is determined that the difference block 920 has not become smaller than the target block 900 (NO at S1810), the process depicted in the flowchart of FIG. 32 ends.

At S1811, the data reduction program 222 writes the difference block 920 in an available region in the storage device 240. Next, the data reduction program 222 adds 1 to the referencing count 1111 of the base block 900 in the block management table 1100 (S1812). Thereafter, the process proceeds to S1813.

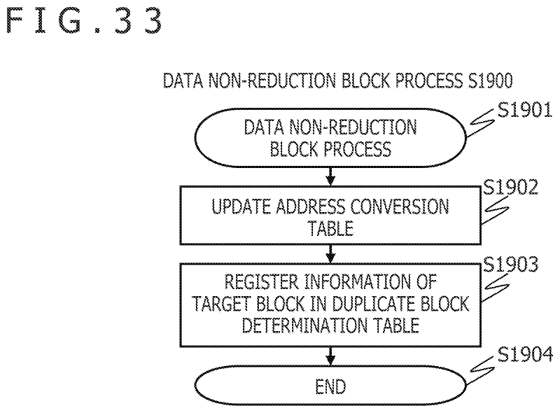

FIG. 33 is a flowchart depicting an example of the data non-reduction block process of the storage system 200 according to the fourth embodiment.

First, the data reduction program 222 updates the address conversion table 1000 (S1902). Next, the data reduction program 222 registers information of the target block 900 in the duplicate block determination table 1200 (S1903), and the process depicted in the flowchart of FIG. 33 ends.

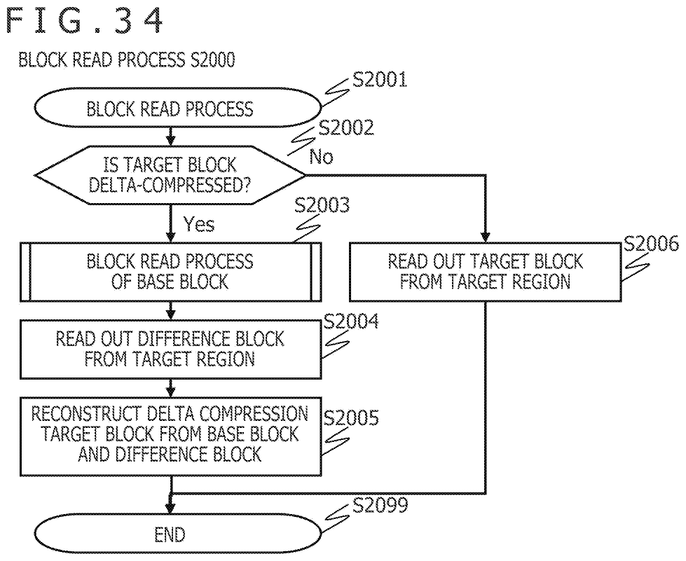

FIG. 34 is a flowchart depicting an example of the block read process of the storage system 200 according to the fourth embodiment. The block read process depicted in the flowchart in FIG. 34 is triggered by a file read request from the host 21.

First, by referring to the delta compression flag 1112 in the block management table 1100, the data reduction program 222 determines whether or not a target block 900 which is the target of the read request is delta-compressed (S2002). Then, if it is determined that the target block 900 is delta-compressed (YES at S2002), the process proceeds to S2003, and if it is determined that the target block 900 is not delta-compressed (NO at S2002), the process proceeds to S2006.

At S2003, the data reduction program 222 reads out a base block 900. Next, the data reduction program 222 reads out a difference block 920 from a target region in the storage device 240 (S2004). Furthermore, the data reduction program 222 reconstructs a delta compression target block 910 from the base block 900 and the difference block 920 (S2005), and the process depicted in the flowchart of FIG. 34 ends.

At S2006, since the target block 900 is neither a duplicate block 900 nor a difference block 920, the data reduction program 222 reads out the target block 900 from a target region in the storage device 240, and the process depicted in the flowchart of FIG. 34 ends.

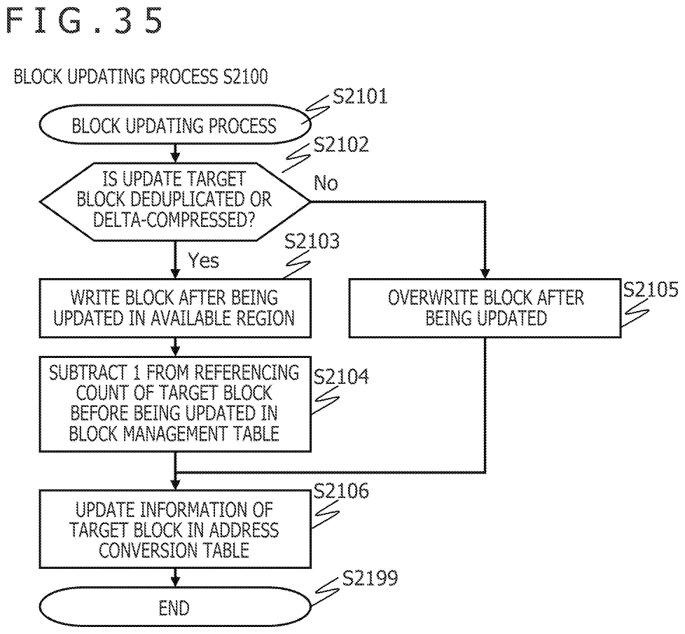

FIG. 35 is a flowchart depicting an example of a block updating process of the storage system 200 according to the fourth embodiment. The block updating process depicted in the flowchart in FIG. 35 is triggered by a file write request from the host 21.

First, by referring to the address conversion table 1000, the data reduction program 222 determines whether or not a target block 900 which is also the target of the write request is deduplicated or delta-compressed (S2102). Then, if it is determined that the target block 900 is deduplicated or delta-compressed (YES at S2102), the block 900 after being updated is written in a target region in the storage device 240 (S2103), and if it is determined that the target block 900 is neither deduplicated nor delta-compressed (NO at S2102), the process proceeds to S2105.

After S2103, the data reduction program 222 subtracts 1 from the referencing count 1111 of the block 900 before being updated in the block management table 1100 (S2104). On the other hand, at S2105, the data reduction program 222 overwrites the block 900 after being updated.

Then, the data reduction program 222 updates information of the target block 900 in the address conversion table 1000, and the process depicted in the flowchart of FIG. 35 ends.

Accordingly, according to the present embodiment also, advantages similar to those in the first embodiment mentioned above can be attained.

### Fifth Embodiment

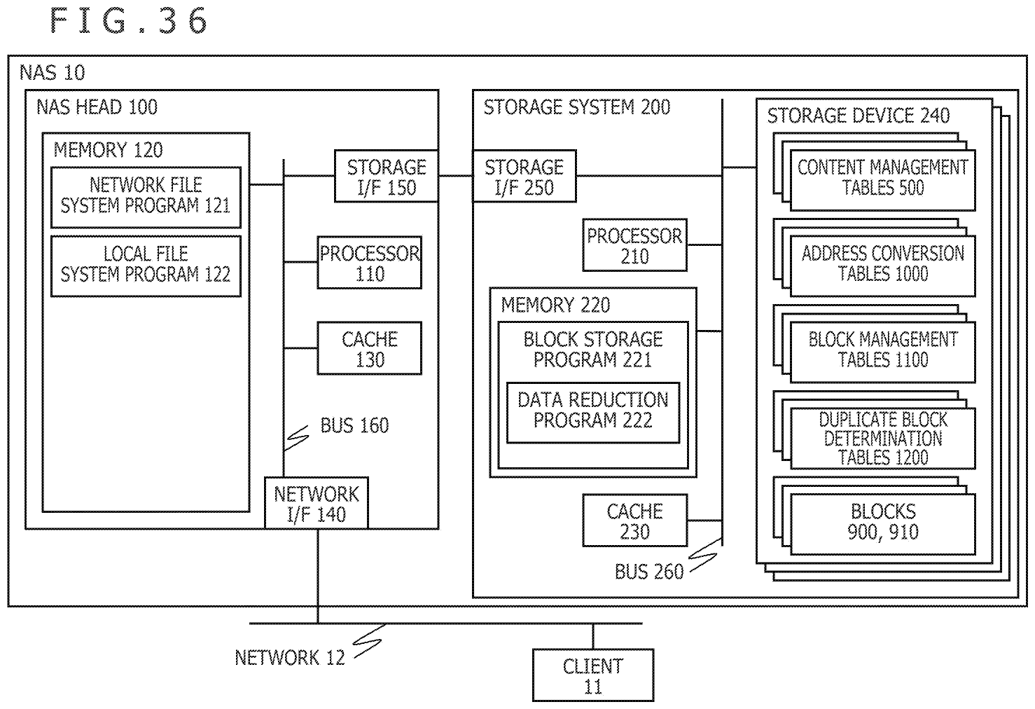

FIG. 36 is a block diagram depicting the schematic configuration of the NAS 10 according to a fifth embodiment.

The NAS 10, which is a storage system in the present embodiment, has the NAS head 100 depicted in the first embodiment, and the storage system 200 depicted in the fourth embodiment. At this time, the program that performs a data reduction process is the data reduction program 222 stored in the memory 220 of the storage system 200. In addition, the storage device 240 of the storage system 200 stores content management tables 501 in addition to various types of data stored on the storage device 240 in the fourth embodiment.

The basic operation in the present embodiment is the same as that in the fourth embodiment, and, as various types of process which are not depicted, various types of process in the fourth embodiment having been explained already are performed. Hereinafter, mainly, operation different from the operation in the fourth embodiment is explained.

In the present embodiment, the NAS head 100 provides information related to updating of block data to the storage system 200, and the data reduction program 222 of the storage system 200 performs a data reduction process.

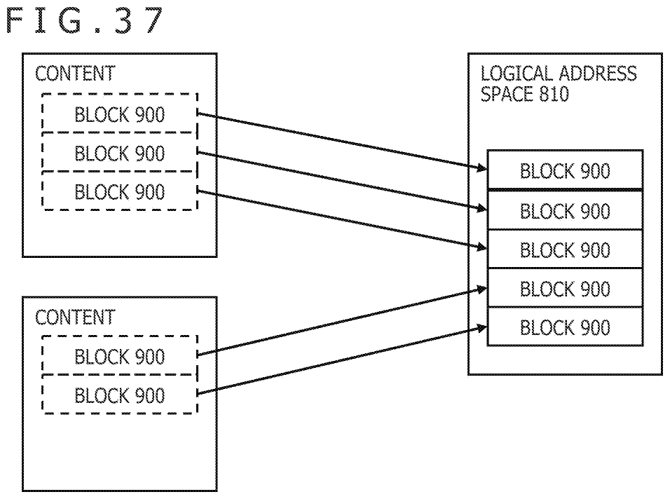

FIG. 37 is a figure depicting an example of the configuration of data stored on the NAS 10 according to the fifth embodiment.

As depicted in FIG. 37, in the NAS 10 in the present embodiment, the host 21 performs operation of each content by using a file system provided by the local file system program 122. Similarly to the fourth embodiment, there are a plurality of fixed-length blocks 900 in the logical address space 810 of the storage system 200, and each content includes at least one block 900.

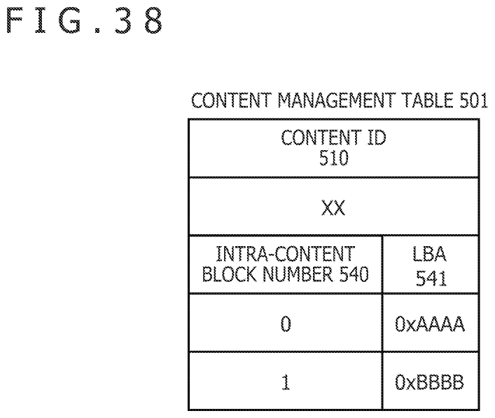

FIG. 38 is a figure depicting an example of the configuration of content management tables of the storage system 200 according to the fifth embodiment.

A content management table 501 is created for each content. A content ID 510 stores an ID that identifies each content. Intra-content block numbers 540 store numbers that identify blocks included in the content. LBAs 541 store logical addresses of the blocks 900 identified by the intra-content block numbers 540.

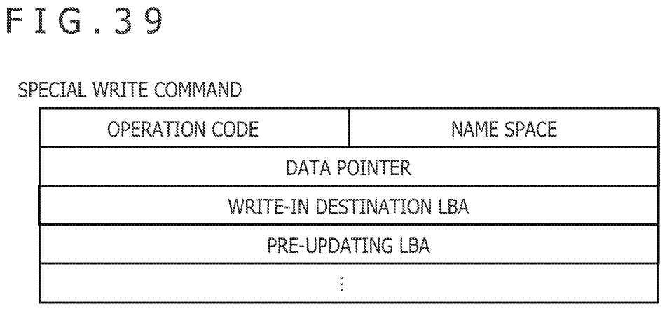

FIG. 39 is a figure depicting an example of the configuration of a special write command of the NAS 10 according to the fifth embodiment. The special write command depicted in FIG. 39 is issued when a write request from the NAS head 100 is issued to the storage system 200.

The special write command has an operation code, a name space, a data pointer, a write-in destination LBA and a pre-updating LBA. The special write command in the present embodiment additionally has a pre-updating LBA that identifies an LBA before updating of block data, as compared to a normal write command.

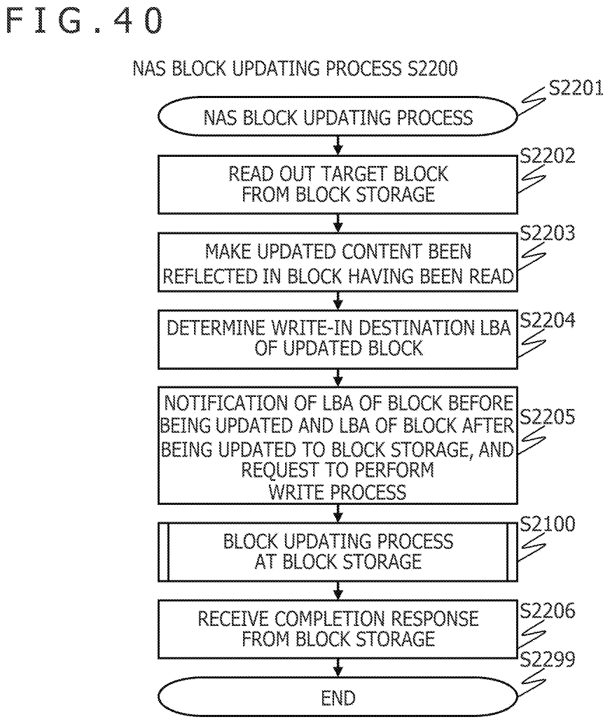

FIG. 40 is a flowchart depicting an example of an NAS block updating process of the NAS 10 according to the fifth embodiment. The NAS block updating process of FIG. 40 is executed by the processor 110 of the NAS head 100 when triggered by a file write request from the client 11.

First, the processor 110 reads out a target block 900 which is the target of the write request from the storage system 200, which is a block storage (S2202). Next, the processor 110 makes an updated content been reflected in the block which has been read at S2202 (S2203). Next, the processor 110 determines a write-in destination LBA of the updated block 900 (S2204). Furthermore, the processor 110 notifies the storage system 200 of an LBA of the block before being updated 900 and an LBA of the block 900 after being updated (i.e. the write-in destination) by using the special write command, and requests a write process.

Thereafter, the storage system 200 executes a subroutine 52100 (block updating process) depicted in FIG. 35, and notifies a write completion notification to the NAS head 100. The processor 110 receives the write completion notification from the storage system 200 (S2206), and the process depicted in FIG. 40 ends.

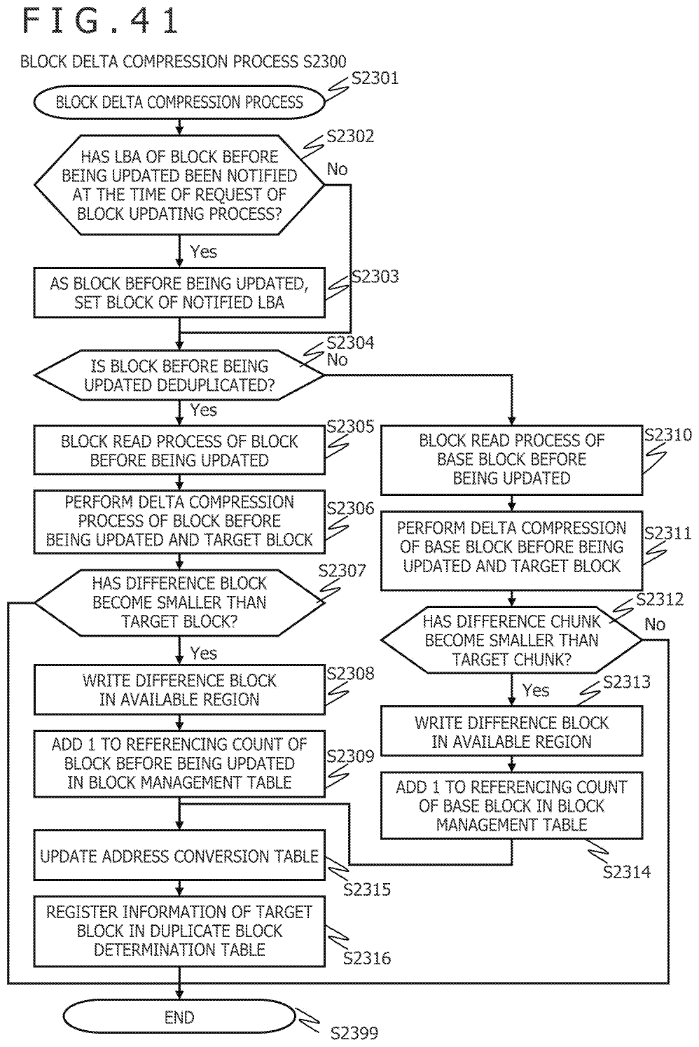

FIG. 41 is a flowchart depicting an example of a block delta compression process of the storage system 200 according to the fifth embodiment. The block delta compression process depicted in the flowchart of FIG. 41 additionally has a task of identifying a block before being updated 900 by using an LBA of a block before being updated notified from the NAS head 100, as compared to the block delta compression process in the fourth embodiment depicted in the flowchart of FIG. 32.

That is, the data reduction program 222 determines whether or not the LBA of the block before being updated 900 is notified at the time of a request for the block updating process from the NAS head 100 (S2302). Then, if it is determined that the LBA of the block before being updated 900 is notified (YES at S2302), the process proceeds to S2303, and if it is determined that the LBA of the block before being updated 900 is not notified (NO at S2302), the process proceeds to S2304. At S2303, as the block before being updated 900, the data reduction program 222 sets the block 900 of the notified LBA.

As processes at and after S2304, processes identical to the processes at S1802 to S1814 in FIG. 32 are performed.

Accordingly, according to the present embodiment also, advantages similar to those in the fourth embodiment mentioned above can be attained.

Note that configurations of the embodiments described above are explained in detail in order to explain the present invention in an easy-to-understand manner, and the present invention is not necessarily limited to embodiments including all the configurations explained. In addition, some of the configurations of each embodiment can be added to other configurations, deleted or replaced with other configurations.

In addition, each configuration, function, processing section, processing means or the like described above may be partially or entirely realized by hardware by, for example, designing it in an integrated circuit, and so on. In addition, the present invention can also be realized by a software program code that realizes functions of the embodiments. In this case, a storage medium having the program code recorded thereon is provided to a computer, and a processor included in the computer reads out the program code stored on the storage medium. In this case, this results in the program code itself read out from the storage medium realizing the functions of the embodiments mentioned before, and the program code itself and the storage medium storing the program code are included in the present invention. Examples of such a storage medium used to supply the program code include, for example, a flexible disk, a CD-ROM, a DVD-ROM, a hard disk, a solid state drive (SSD), an optical disk, a magneto-optical disk, a CD-R, a magnetic tape, a non-volatile memory card, a ROM and the like.

In addition, the program code that realizes functions described in the present embodiments can be implemented by a wide range of programs or script languages such as, for example, assemblers, C/C++, perl, Shell, PHP, Java (registered trademark) or Python.

Control lines and information lines that are considered to be necessary for explanation are depicted in the embodiments mentioned above, and all control lines and information lines that are necessary for products are not necessarily depicted. All configurations may be connected mutually.

What is claimed is:

1. A storage system comprising:
a storage device that stores data; and
a processor that processes the data stored on the storage device, wherein
the storage system has a deduplication function of performing deduplication on a plurality of duplicate pieces of the data and a delta compression function of storing differences between a plurality of similar pieces of the data, and
when a write request to update the stored data is received,
in a case where the deduplication has been performed on the data before being updated according to the write request, and the data after being updated does not share duplicate data with second data, the processor performs the delta compression of generating and storing a difference between the data before being updated and the data after being updated.

2. The storage system according to claim 1, wherein
a duplicate determination is made about the data after being updated,
in a case where the data after being updated shares duplicate data with the second data, deduplication is performed with the second data, and
in a case where the data after being updated does not share duplicate data with the second data, and the data before being updated is duplicate data, the delta compression is performed.

3. The storage system according to claim 2, wherein
in a case where the data after being updated does not share duplicate data with the second data, and the data before being updated is not duplicate data, the data after being updated is stored on the storage device.

4. The storage system according to claim 1, wherein
when a write request to re-update update data on which the delta compression has been performed is received,
the processor makes a duplicate determination about the data after being re-updated,
performs deduplication with the second data in a case where the data after being re-updated shares duplicate data with the second data, and
performs the delta compression with the data before being updated in a case where the data after being re-updated does not share duplicate data with the second data.

5. The storage system according to claim 1, wherein,
in a case where the deduplication has been performed on the data before being updated according to the write request, and the data after being updated does not share duplicate data with the second data, the data is stored in a form with a smaller data amount that is determined by comparing a difference data amount in a case where the delta compression is performed and a post-updating data amount in a case where the delta compression is not performed.

6. The storage system according to claim 1, wherein
before the data is updated and after the data is updated according to the write request, the data before being updated in the storage device is referenced by the second data due to the deduplication function, and is stored in the storage device without being deleted after the data is updated.

7. The storage system according to claim 1, wherein
a file includes a data array in which a plurality of pieces of the data are sorted in order,
updating of the file includes insertion of the data into the data array and deletion of the data from the data array, and
in a case where the file has been updated, a duplicate determination is made about the data between the file before being updated and the file after being updated, and on a basis of the duplicate determination, insertion of the data and deletion of the data are sensed and reference data for the delta compression is changed.

8. The storage system according to claim 1, wherein
a file includes a plurality of pieces of the data,
the processor identifies a representative file on a basis of the number of referenced pieces of data that are referenced by the data in the file due to the deduplication and the delta compression, and
the processor performs delta compression relative to the representative file.

9. The storage system according to claim 1, wherein
the storage system includes a superordinate management system, and
according to a notification from the superordinate management system, the storage system identifies the data before being updated.

10. A method of data amount reduction in a storage system including a storage device that stores data and a processor that processes the data stored on the storage device, the storage system having a deduplication function of performing deduplication on a plurality of duplicate pieces of the data and a delta compression function of storing differences between a plurality of similar pieces of the data, the method comprising:
when a write request to update the stored data is received,
in a case where the deduplication has been performed on the data before being updated according to the write request, and the data after being updated does not share duplicate data with second data,
performing the delta compression of generating and storing a difference between the data before being updated and the data after being updated.
